(19) United States
(12) Patent Application Publication
(10) Pub. No.: US 2026/0287851 A1
(43) Pub. Date: Sep. 24, 2026

(54) PHOTOGRAPHING LENS SYSTEM, IMAGE CAPTURING UNIT AND ELECTRONIC DEVICE

(71) Applicant: LARGAN PRECISION CO., LTD., Taichung City (TW)

(72) Inventors: Guan-Bo LIN, Taichung City (TW); Kuo-Jui WANG, Taichung City (TW)

(73) Assignee: LARGAN PRECISION CO., LTD., Taichung City (TW)

(21) Appl. No.: 19/251,078

(22) Filed: Jun. 26, 2025

(30) Foreign Application Priority Data
Mar. 24, 2025 (TW) 114110993

(51) Int. Cl. G02B 9/60; G02B 13/18

(52) U.S. Cl. CPC G02B 9/60; G02B 13/18

(57) ABSTRACT

A photographing lens system includes five lens elements which are, in order from an object side to an image side along an optical path: a first lens element, a second lens element, a third lens element, a fourth lens element and a fifth lens element. The first lens element has positive refractive power. The second lens element has positive refractive power. The third lens element has an object-side surface being concave in a paraxial region thereof and an image-side surface being convex in a paraxial region thereof. The fourth lens element with negative refractive power has an object-side surface being concave in a paraxial region thereof. The fifth lens element with positive refractive power has an object-side surface being convex in a paraxial region thereof and an image-side surface being concave in a paraxial region thereof.

### RELATED APPLICATIONS

This application claims priority to Taiwan Application 114110993, filed on Mar. 24, 2025, which is incorporated by reference herein in its entirety.

### BACKGROUND

### Technical Field

The present disclosure relates to a photographing lens system, an image capturing unit and an electronic device, more particularly to a photographing lens system and an image capturing unit applicable to an electronic device.

### Description of Related Art

With the development of semiconductor manufacturing technology, the performance of image sensors has improved, and the pixel size thereof has been scaled down. Therefore, featuring high image quality becomes one of the indispensable features of an optical system nowadays.

Furthermore, due to the rapid changes in technology, electronic devices equipped with optical systems are trending towards multi-functionality for various applications, and therefore the functionality requirements for the optical systems have been increasing. However, it is difficult for a conventional optical system to obtain a balance among the requirements such as high image quality, low sensitivity, a proper aperture size, miniaturization and a desirable field of view.

### SUMMARY

According to one aspect of the present disclosure, a photographing lens system includes five lens elements. The five lens elements are, in order from an object side to an image side along an optical path, a first lens element, a second lens element, a third lens element, a fourth lens element and a fifth lens element. Each of the five lens elements has an object-side surface facing toward the object side and an image-side surface facing toward the image side.

Preferably, the first lens element has positive refractive power. Preferably, the second lens element has positive refractive power. Preferably, the object-side surface of the third lens element is concave in a paraxial region thereof. Preferably, the image-side surface of the third lens element is convex in a paraxial region thereof. Preferably, the fourth lens element has negative refractive power. Preferably, the object-side surface of the fourth lens element is concave in a paraxial region thereof. Preferably, the fifth lens element has positive refractive power. Preferably, the object-side surface of the fifth lens element is convex in a paraxial region thereof. Preferably, the image-side surface of the fifth lens element is concave in a paraxial region thereof.

When an Abbe number of the third lens element is V3, an Abbe number of the fourth lens element is V4, a focal length of the third lens element is f3, a focal length of the fourth lens element is f4, a focal length of the fifth lens element is f5, and a focal length of the photographing lens system is f, the following conditions are preferably satisfied:

$$20. < V 3 + V 4 < 65. ; \\ 0. < \vert f 4 / f 3 \vert < 0.8 ; and \\ 1.5 < \vert f 4 / f \vert + \vert f 5 / f \vert < 7. .$$

According to another aspect of the present disclosure, a photographing lens system includes five lens elements. The five lens elements are, in order from an object side to an image side along an optical path, a first lens element, a second lens element, a third lens element, a fourth lens element and a fifth lens element. Each of the five lens elements has an object-side surface facing toward the object side and an image-side surface facing toward the image side.

Preferably, the first lens element has positive refractive power. Preferably, the second lens element has positive refractive power. Preferably, the object-side surface of the third lens element is concave in a paraxial region thereof. Preferably, the image-side surface of the third lens element is convex in a paraxial region thereof. Preferably, the fourth lens element has negative refractive power. Preferably, the object-side surface of the fourth lens element is concave in a paraxial region thereof. Preferably, the fifth lens element has positive refractive power. Preferably, the object-side surface of the fifth lens element is convex in a paraxial region thereof. Preferably, the image-side surface of the fifth lens element is concave in a paraxial region thereof.

When an Abbe number of the third lens element is V3, an Abbe number of the fourth lens element is V4, an Abbe number of the fifth lens element is V5, a composite focal length of the second lens element and the third lens element is f23, and a focal length of the photographing lens system is f, the following conditions are preferably satisfied:

$$20. < V 3 + V 4 < 65. ; \\ 1.15 < f 23 / f < 5. ; and \\ 25. < V 5 - V 4 < 45.0 .$$

According to another aspect of the present disclosure, a photographing lens system includes five lens elements. The five lens elements are, in order from an object side to an image side along an optical path, a first lens element, a second lens element, a third lens element, a fourth lens element and a fifth lens element. Each of the five lens elements has an object-side surface facing toward the object side and an image-side surface facing toward the image side.

Preferably, the first lens element has positive refractive power. Preferably, the second lens element has positive refractive power. Preferably, the object-side surface of the third lens element is concave in a paraxial region thereof. Preferably, the image-side surface of the third lens element is convex in a paraxial region thereof. Preferably, the fourth lens element has negative refractive power. Preferably, the object-side surface of the fourth lens element is concave in a paraxial region thereof. Preferably, the fifth lens element has positive refractive power. Preferably, the object-side surface of the fifth lens element is convex in a paraxial region thereof. Preferably, the image-side surface of the fifth lens element is concave in a paraxial region thereof.

When an Abbe number of the third lens element is V3, an Abbe number of the fourth lens element is V4, a focal length of the photographing lens system is f, a focal length of the fourth lens element is f4, a focal length of the fifth lens element is f5, and a curvature radius of the object-side surface of the third lens element is R5, the following conditions are preferably satisfied:

$$20. < V 3 + V 4 < 65. ; \\ - 3. < f / R 5 < - 1. ; and \\ - 2.2 < f 5 / f 4 < - 1. .$$

According to another aspect of the present disclosure, an image capturing unit includes the aforementioned photographing lens system and an image sensor, wherein the image sensor is disposed on an image surface of the photographing lens system.

According to another aspect of the present disclosure, an electronic device includes an image capturing unit. The image capturing unit includes the aforementioned photographing lens system and an image sensor, wherein the image sensor is disposed on an image surface of the photographing lens system.

### BRIEF DESCRIPTION OF THE DRAWINGS

The disclosure can be better understood by reading the following detailed description of the embodiments, with reference made to the accompanying drawings as follows:

FIG. 1 is a schematic view of an image capturing unit according to the 1st embodiment of the present disclosure;

FIG. 2 shows spherical aberration curves, astigmatic field curves and a distortion curve of the image capturing unit according to the 1st embodiment;

FIG. 3 is a schematic view of an image capturing unit according to the 2nd embodiment of the present disclosure;

FIG. 4 shows spherical aberration curves, astigmatic field curves and a distortion curve of the image capturing unit according to the 2nd embodiment;

FIG. 5 is a schematic view of an image capturing unit according to the 3rd embodiment of the present disclosure;

FIG. 6 shows spherical aberration curves, astigmatic field curves and a distortion curve of the image capturing unit according to the 3rd embodiment;

FIG. 7 is a schematic view of an image capturing unit according to the 4th embodiment of the present disclosure;

FIG. 8 shows spherical aberration curves, astigmatic field curves and a distortion curve of the image capturing unit according to the 4th embodiment;

FIG. 9 is a schematic view of an image capturing unit according to the 5th embodiment of the present disclosure;

FIG. 10 shows spherical aberration curves, astigmatic field curves and a distortion curve of the image capturing unit according to the 5th embodiment;

FIG. 11 is a schematic view of an image capturing unit according to the 6th embodiment of the present disclosure;

FIG. 12 shows spherical aberration curves, astigmatic field curves and a distortion curve of the image capturing unit according to the 6th embodiment;

FIG. 13 is a schematic view of an image capturing unit according to the 7th embodiment of the present disclosure;

FIG. 14 shows spherical aberration curves, astigmatic field curves and a distortion curve of the image capturing unit according to the 7th embodiment;

FIG. 15 is a schematic view of an image capturing unit according to the 8th embodiment of the present disclosure;

FIG. 16 shows spherical aberration curves, astigmatic field curves and a distortion curve of the image capturing unit according to the 8th embodiment;

FIG. 17 is a schematic view of an image capturing unit according to the 9th embodiment of the present disclosure;

FIG. 18 shows spherical aberration curves, astigmatic field curves and a distortion curve of the image capturing unit according to the 9th embodiment;

FIG. 19 is a perspective view of an image capturing unit according to the 10th embodiment of the present disclosure;

FIG. 20 is one schematic view of an electronic device according to the 11th embodiment of the present disclosure;

FIG. 21 is another schematic view of the electronic device in FIG. 20;

FIG. 22 is one perspective view of an electronic device according to the 12th embodiment of the present disclosure;

FIG. 23 is another perspective view of the electronic device in FIG. 22;

FIG. 24 is a block diagram of the electronic device in FIG. 22;

FIG. 25 is a perspective view of an electronic device according to the 13th embodiment of the present disclosure;

FIG. 26 is a perspective view of an electronic device according to the 14th embodiment of the present disclosure;

FIG. 27 shows a schematic view of inflection points and critical points on lens surfaces according to the 1st embodiment of the present disclosure;

FIG. 28 shows a schematic view of a configuration of one light-folding element in a photographing lens system according to one embodiment of the present disclosure;

FIG. 29 shows a schematic view of another configuration of one light-folding element in a photographing lens system according to one embodiment of the present disclosure; and

FIG. 30 shows a schematic view of a configuration of two light-folding elements in a photographing lens system according to one embodiment of the present disclosure.

### DETAILED DESCRIPTION

A photographing lens system includes five lens elements. The five lens elements are, in order from an object side to an image side along an optical path, a first lens element, a second lens element, a third lens element, a fourth lens element and a fifth lens element. Each of the five lens elements of the photographing lens system has an object-side surface facing toward the object side and an image-side surface facing toward the image side.

The first lens element can have positive refractive power. Therefore, it is favorable for reducing the overall size and enhancing the light-gathering capability of the photographing lens system. The object-side surface of the first lens element can be convex in a paraxial region thereof. Therefore, it is favorable for increasing the aperture size to enhance the amount of incident light. The object-side surface of the first lens element can also be concave in a paraxial region thereof. Therefore, it is favorable for reducing the thickness of the first lens element and increasing the light-collection angle. The image-side surface of the first lens element can be convex in a paraxial region thereof. Therefore, it is favorable for increasing the positive refractive power of the first lens element to enhance the converging capability. The image-side surface of the first lens element can also be concave in a paraxial region thereof. Therefore, it is favorable for reducing ghost images or flare generated by the object-side and image-side surfaces of the first lens element.

The second lens element can have positive refractive power. Therefore, it is favorable for sharing the converging power at the object-side end of the photographing lens system, thereby reducing aberration generation. The object-side surface of the second lens element can be convex in a paraxial region thereof. Therefore, it is favorable for adjusting the light path between the first lens element and the second lens element so as to prevent the generation of ghost images or flare. The object-side surface of the second lens element can also be concave in a paraxial region thereof. Therefore, it is favorable for controlling the incident angle of marginal rays entering the second lens element, thereby preventing total internal reflection caused by excessively large angles. The image-side surface of the second lens element can be convex in a paraxial region thereof. Therefore, it is favorable for increasing the light-converging capability of the second lens element. The image-side surface of the second lens element can also be concave in a paraxial region thereof. Therefore, it is favorable for increasing the composite focal length of the first lens element and the second lens element.

The third lens element can have positive refractive power. Therefore, it is favorable for balancing the refractive power of the photographing lens system to reduce distortion. The third lens element can also have negative refractive power. Therefore, it is favorable for balancing the refractive power of the photographing lens system to reduce axial chromatic aberration. The object-side surface of the third lens element can be concave in a paraxial region thereof. Therefore, it is favorable for adjusting the light path incident on the third lens element to reduce the occurrence of total internal reflection. The image-side surface of the third lens element can be convex in a paraxial region thereof. Therefore, it is favorable for cooperating with the shape of the object-side surface of the third lens element to reduce the occurrence of total internal reflection.

The fourth lens element can have negative refractive power. Therefore, it is favorable for cooperating with the fifth lens element to correct aberrations. The object-side surface of the fourth lens element can be concave in a paraxial region thereof. Therefore, it is favorable for reducing spherical aberration of the photographing lens system. The image-side surface of the fourth lens element can be convex in a paraxial region thereof. Therefore, it is favorable for adjusting the surface shape of the fourth lens element to control the incident angle of light entering the fifth lens element. The image-side surface of the fourth lens element can also be concave in a paraxial region thereof. Therefore, it is favorable for increasing the axial distance between the third lens element and the fourth lens element to balance the lens configuration.

The fifth lens element can have positive refractive power. Therefore, it is favorable for providing sufficient light-converging capability at the image-side end of the photographing lens system so as to assist in correcting the incident angle of light at the image-side end. The object-side surface of the fifth lens element can be convex in a paraxial region thereof. Therefore, it is favorable for adjusting the surface shape of the fifth lens element so as to converge light and adjust the back focal length. The image-side surface of the fifth lens element can be concave in a paraxial region thereof. Therefore, it is favorable for adjusting the surface shape of the fifth lens element so as to reduce aberrations.

The photographing lens system can further include an aperture stop disposed on an object side of the first lens element. Therefore, it is favorable for reducing the total track length of the photographing lens system.

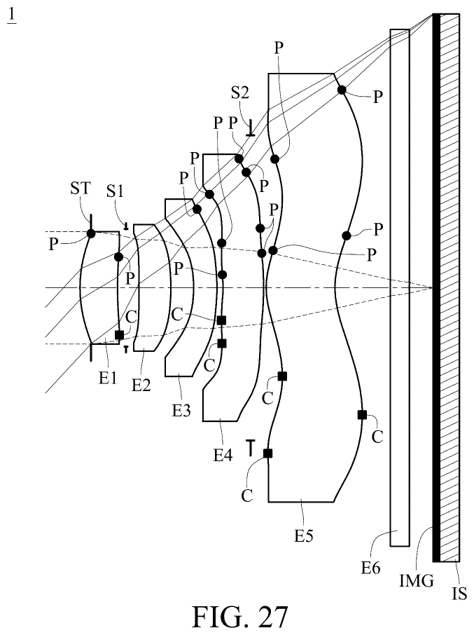

According to the present disclosure, the image-side surface of the fifth lens element can have at least one inflection point. Therefore, it is favorable for controlling peripheral image aberrations while also contributing to size reduction. Please refer to FIG. 27, which shows a schematic view of the inflection points P of the image-side surface of the fifth lens element E5 according to the 1st embodiment of the present disclosure. FIG. 27 shows, in the 1st embodiment of the present disclosure, the inflection points P located on the image-side surface of the fifth lens element E5, along with the inflection points P on the object-side surface and the image-side surface of the first lens element E1, the image-side surface of the third lens element E3, the object-side surface and the image-side surface of the fourth lens element E4, and the object-side surface of the fifth lens element E5, as an exemplary illustration. However, in various embodiments of the present disclosure, each of the lens surfaces of the lens elements can have one or more inflection points.

According to the present disclosure, the image-side surface of the fifth lens element can have at least one critical point in an off-axis region thereof. Therefore, it is favorable for collaborating with the inflection point(s) so as to enhance the control of peripheral image aberrations, while also further contributing to size reduction. Please refer to FIG. 27, which shows a schematic view of the non-axial critical point C of the image-side surface of the fifth lens element E5 according to the 1st embodiment of the present disclosure. FIG. 27 shows, in the 1st embodiment of the present disclosure, the non-axial critical point C located on the image-side surface of the fifth lens element E5, along with the non-axial critical points C on the image-side surface of the first lens element E1, the object-side surface of the fourth lens element E4, and the object-side surface of the fifth lens element E5, as an exemplary illustration. However, in various embodiments of the present disclosure, each of the lens surfaces of the lens elements can have one or more critical points in an off-axis region thereof.

According to the present disclosure, a central thickness of the first lens element can be larger than an average central thickness of all lens elements in the photographing lens system. Therefore, it is favorable for reducing the size of the photographing lens system, allowing the overall shape thereof to meet miniaturization requirements.

According to the present disclosure, at least one of the first lens element and the second lens element can be made of glass material. Therefore, it is favorable for enhancing the light-collecting capability and refractive power of the first lens element or the second lens element, adjusting the dispersion characteristics to reduce chromatic aberration, and also contributing to size reduction.

When an Abbe number of the third lens element is V3, and an Abbe number of the fourth lens element is V4, the following condition can be satisfied: 20.0<V3+V4<65.0. Therefore, it is favorable for controlling the dispersion characteristics between the third lens element and the fourth lens element, thereby facilitating the third lens element and the fourth lens element working together with the second lens element or the fifth lens element to reduce chromatic aberration. Moreover, the following condition can also be satisfied: 25.0<V3+V4<60.0. Moreover, the following condition can also be satisfied: 25.0<V3+V4<55.0. Moreover, the following condition can also be satisfied: 28.0≤V3+V4≤51.2.

When a focal length of the third lens element is f3, and a focal length of the fourth lens element is f4, the following condition can be satisfied: 0.00<|f4/f3|<1.00. Therefore, it is favorable for controlling the refractive power ratio between the third lens element and the fourth lens element so as to reduce aberrations. Moreover, the following condition can also be satisfied: 0.00<|f4/f3|<0.80. Moreover, the following condition can also be satisfied: 0.00<|f4/f3|<0.70. Moreover, the following condition can also be satisfied: 0.00<|f4/f3|<0.60. Moreover, the following condition can also be satisfied: 0.01≤|f4/f3|≤0.56.

When the focal length of the fourth lens element is f4, a focal length of the fifth lens element is f5, and a focal length of the photographing lens system is f, the following condition can be satisfied: 1.50<|f4/fJ+|f5/fJ<7.00. Therefore, it is favorable for balancing the refractive power of the fourth lens element and the fifth lens element, thereby effectively reducing the back focal length. Moreover, the following condition can also be satisfied: 1.60<|f4/f1+|f5/f1<6.50. Moreover, the following condition can also be satisfied: 1.80<|f4/f1+|f5/f1<5.50. Moreover, the following condition can also be satisfied: 2.08≤|f4/f1+|f5/f1≤5.24.

When a composite focal length of the second lens element and the third lens element is f23, and the focal length of the photographing lens system is f, the following condition can be satisfied: 1.15<f23/f<5.00. Therefore, it is favorable for controlling the light-converging capability from the second lens element to the third lens element to improve astigmatism correction. Moreover, the following condition can also be satisfied: 1.20<f23/f<4.50. Moreover, the following condition can also be satisfied: 1.25<f23/f<4.00. Moreover, the following condition can also be satisfied: 1.30≤f23/f≤3.87.

When the Abbe number of the fourth lens element is V4, and an Abbe number of the fifth lens element is V5, the following condition can be satisfied: 25.0<V5−V4<45.0. Therefore, it is favorable for controlling the dispersion difference between the fourth lens element and the fifth lens element to help select lens materials that reduce chromatic aberration. Moreover, the following condition can also be satisfied: 26.0<V5−V4<43.0. Moreover, the following condition can also be satisfied: 27.7<V5−V4≤42.0.

When the focal length of the photographing lens system is f, and a curvature radius of the object-side surface of the third lens element is R5, the following condition can be satisfied: −3.00<f/R5<−1.00. Therefore, it is favorable for adjusting the incident light angle on the object-side surface of the third lens element so as to increase the field of view and reduce overall size. Moreover, the following condition can also be satisfied: −2.70<f/R5<−1.10. Moreover, the following condition can also be satisfied: −2.20<f/R5<−1.20. Moreover, the following condition can also be satisfied: −2.08≤f/R5≤−1.31.

When the focal length of the fourth lens element is f4, and the focal length of the fifth lens element is f5, the following condition can be satisfied: −2.20<f5/f4<−1.00. Therefore, it is favorable for balancing the refractive power of the fourth lens element and the fifth lens element, thereby reducing aberrations. Moreover, the following condition can also be satisfied: −2.10<f5/f4<−1.10. Moreover, the following condition can also be satisfied: −1.90≤f5/f4≤−1.14.

When the Abbe number of the third lens element is V3, and the Abbe number of the fourth lens element is V4, the following condition can be satisfied: 0.00≤V4-V3<10.00. Therefore, it is favorable for controlling the dispersion difference between the third lens element and the fourth lens element for selecting lens materials to achieve the effect of reducing chromatic aberration. Moreover, the following condition can also be satisfied: 0.00≤V4-V3<9.00.

When the focal length of the photographing lens system is f, and a curvature radius of the image-side surface of the third lens element is R6, the following condition can be satisfied: −4.00<f/R6<−1.00. Therefore, it is favorable for adjusting the light-converging capability of the image-side surface of the third lens element to increase the field of view and reduce overall size. Moreover, the following condition can also be satisfied: −3.00<f/R6<−1.50.

When the curvature radius of the object-side surface of the third lens element is R5, and an axial distance between the object-side surface of the third lens element and an image surface is Dr5I, the following condition can be satisfied: −1.25<R5/Dr5I<−0.20. Therefore, it is favorable for controlling the angle at which light proceeds toward the image-side surface of the third lens element. Moreover, the following condition can also be satisfied: −1.00<R5/Dr5I<−0.25.

When the curvature radius of the image-side surface of the third lens element is R6, and an axial distance between the image-side surface of the third lens element and the image surface is Dr6I, the following condition can be satisfied: −1.50<R6/Dr6I<−0.25. Therefore, it is favorable for increasing light-converging capability to reduce overall size. Moreover, the following condition can also be satisfied: −1.20<R6/Dr6I<−0.30.

When an axial distance between the object-side surface of the first lens element and the image surface is TL, and a maximum image height of the photographing lens system (which can be half of a diagonal length of an effective photosensitive area of an image sensor) is ImgH, the following condition can be satisfied: 1.00<TL/ImgH<1.50. Therefore, it is favorable for controlling an appropriate ratio between the total track length and image height of the photographing lens system, ensuring sufficient image brightness while pursuing miniaturization of the photographing lens system. Moreover, the following condition can also be satisfied: 1.05<TL/ImgH<1.40. Moreover, the following condition can also be satisfied: 1.15<TL/ImgH<1.35.

When the axial distance between the object-side surface of the first lens element and the image surface is TL, and the focal length of the photographing lens system is f, the following condition can be satisfied: 1.00<TL/f<1.80. Therefore, it is favorable for balancing the total track length of the photographing lens system and the field of view. Moreover, the following condition can also be satisfied: 1.20<TL/f<1.70. Moreover, the following condition can also be satisfied: 1.30<TL/f<1.55.

When the Abbe number of the fourth lens element is V4, and the Abbe number of the fifth lens element is V5, the following condition can be satisfied: 0.20<V4/V5<0.60. Therefore, it is favorable for balancing the dispersion ratio between the fourth lens element and the fifth lens element. Moreover, the following condition can also be satisfied: 0.24<V4/V5<0.52.

When half of a maximum field of view of the photographing lens system is HFOV, the following condition can be satisfied: 40.0 degrees<HFOV<60.0 degrees.

Therefore, it is favorable for the photographing lens system to have a sufficient imaging range to meet the field-of-view requirements of the application device.

Moreover, the following condition can also be satisfied: 42.0 degrees<HFOV<55.0 degrees. Moreover, the following condition can also be satisfied: 45.4 degrees<HFOV≤50.2 degrees.

When the focal length of the photographing lens system is f, and a composite focal length of the second lens element, the third lens element, the fourth lens element and the fifth lens element is f2345, the following condition can be satisfied: 0.00<f/f2345<1.00. Therefore, it is favorable for controlling the refractive power from the second lens element to the fifth lens element, and achieving a balance between image quality and miniaturization. Moreover, the following condition can also be satisfied: 0.00<f/f2345<0.80. Moreover, the following condition can also be satisfied: 0.00<f/f2345<0.40.

When an Abbe number of the first lens element is V1, and an Abbe number of the second lens element is V2, the following condition can be satisfied: 100.0<V1+V2<130.0. Therefore, it is favorable for controlling the dispersion characteristics between the first lens element and the second lens element so as to cooperate with the third lens element or the fourth lens element to reduce chromatic aberration. Moreover, the following condition can also be satisfied: 110.0<V1+V2<125.0.

When the Abbe number of the second lens element is V2, and the Abbe number of the third lens element is V3, the following condition can be satisfied: 25.0<V2-V3<45.0. Therefore, it is favorable for controlling the dispersion difference between the second lens element and the third lens element for selecting lens materials to reduce chromatic aberration. Moreover, the following condition can also be satisfied: 28.0<V2-V3<43.0.

When the focal length of the photographing lens system is f, and the focal length of the fifth lens element is f5, the following condition can be satisfied: 0.25<f/f5<1.00. Therefore, it is favorable for controlling the refractive power of the fifth lens element so as to adjust the incident light angle on the image surface, thereby enhancing illuminance or reducing aberrations. Moreover, the following condition can also be satisfied: 0.30<f/f5<0.90.

When the Abbe number of the second lens element is V2, and the Abbe number of the third lens element is V3, the following condition can be satisfied: V3<V2. Therefore, it is favorable for the third lens element to have a lower Abbe number (i.e., higher dispersion) so as to reduce chromatic aberration.

When the Abbe number of the third lens element is V3, and the Abbe number of the fourth lens element is V4, the following condition can be satisfied: V3≤V4. Therefore, it is favorable for controlling the dispersion of the third lens element and the fourth lens element to be similar, or controlling the third lens element to have a lower Abbe number (i.e., higher dispersion), thereby reducing chromatic aberration.

When the central thickness of the first lens element is CT1, a central thickness of the second lens element is CT2, a central thickness of the third lens element is CT3, and a central thickness of the fourth lens element is CT4, the following condition can be satisfied: 1.10<CT1/[(CT2+CT3+CT4)/3]<2.50. Therefore, it is favorable for controlling the thickness ratio of the first lens element within the photographing lens system, ensuring that the first lens element has sufficient refractive power.

Moreover, the following condition can also be satisfied: 1.10<CT1/[(CT2+CT3+CT4)/3]<2.20.

When a sum of central thicknesses of all lens elements of the photographing lens system is ΣCT, and a sum of axial distances between each of all adjacent lens elements of the photographing lens system is ZAT, the following condition can be satisfied: 2.00<ΣCT/ΣAT<5.00. Therefore, it is favorable for balancing the lens configuration of the photographing lens system to enhance light-converging quality. Moreover, the following condition can also be satisfied: 2.20<ICT/IAT<4.80.

When a focal length of the first lens element is f1, and the focal length of the third lens element is f3, the following condition can be satisfied: 0.00<|f1/f3|<1.00. Therefore, it is favorable for controlling the refractive power ratio between the third lens element and the first lens element so as to reduce aberrations or axial chromatic aberration. Moreover, the following condition can also be satisfied: 0.00<|f1/f3|<0.80. Moreover, the following condition can also be satisfied: 0.00<|f1/f3|<0.70.

When a focal length of the second lens element is f2, and the focal length of the third lens element is f3, the following condition can be satisfied: 0.00<|f2/f3|<1.50. Therefore, it is favorable for controlling the refractive power ratio between the third lens element and the second lens element so as to reduce aberrations or distortion. Moreover, the following condition can also be satisfied: 0.00<|f2/f3|<1.30. Moreover, the following condition can also be satisfied: 0.00<|f2/f3|<1.10.

When the focal length of the third lens element is f3, and the focal length of the fifth lens element is f5, the following condition can be satisfied: 0.00<|f5/f3|<1.00. Therefore, it is favorable for controlling the refractive power ratio between the third lens element and the fifth lens element so as to reduce aberrations or coma. Moreover, the following condition can also be satisfied: 0.00<|f5/f3|<0.90. Moreover, the following condition can also be satisfied: 0.00<|f5/f3|<0.80.

When the focal length of the first lens element is f1, and the focal length of the second lens element is f2, the following condition can be satisfied: 0.20<f1/f2<1.00. Therefore, it is favorable for enhancing illuminance and reducing aberrations. Moreover, the following condition can also be satisfied: 0.30<f1/f2<0.90.

According to the present disclosure, the aforementioned features and conditions can be utilized in numerous combinations so as to achieve corresponding effects.

According to the present disclosure, the lens elements of the photographing lens system can be made of either glass or plastic material. When the lens elements are made of glass material, the refractive power distribution of the photographing lens system may be more flexible, and the influence on imaging caused by external environment temperature change may be reduced. The glass lens element can either be made by grinding or molding. When the lens elements are made of plastic material, the manufacturing costs can be effectively reduced. Furthermore, surfaces of each lens element can be arranged to be spherical or aspheric. Spherical lens elements are simple in manufacture. Aspheric lens element design allows more control variables for eliminating aberrations thereof and reducing the required number of lens elements, and the total track length of the photographing lens system can therefore be effectively shortened. Additionally, the aspheric surfaces may be formed by plastic injection molding or glass molding.

According to the present disclosure, when a lens surface is aspheric, it means that the lens surface has an aspheric shape throughout its optically effective area, or a portion(s) thereof.

According to the present disclosure, one or more of the lens elements' material may optionally include an additive which generates light absorption and interference effects and alters the lens elements' transmittance in a specific range of wavelength for a reduction in unwanted stray light or color deviation. For example, the additive may optionally filter out light in the wavelength range of 600 nm to 800 nm to reduce excessive red light and/or near infrared light; or may optionally filter out light in the wavelength range of 350 nm to 450 nm to reduce excessive blue light and/or near ultraviolet light from interfering the final image. The additive may be homogeneously mixed with a plastic material to be used in manufacturing a mixed-material lens element by injection molding. Moreover, the additive may be coated on the lens surfaces to provide the abovementioned effects.

According to the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, unless otherwise stated, when the lens element has a convex surface, it indicates that the surface is convex in the paraxial region thereof; when the lens element has a concave surface, it indicates that the surface is concave in the paraxial region thereof. Moreover, when a region of refractive power, curvature radius or focus of a lens element is not defined, it indicates that the region of refractive power, curvature radius or focus of the lens element is in the paraxial region thereof.

According to the present disclosure, an inflection point is a point on the surface of the lens element at which the surface changes from concave to convex, or vice versa. A critical point is a non-axial point of the lens surface where its tangent is perpendicular to the optical axis.

According to the present disclosure, the image surface of the photographing lens system, based on the corresponding image sensor, can be flat or curved, especially a curved surface being concave facing towards the object side of the photographing lens system.

According to the present disclosure, an image correction unit, such as a field flattener, can be optionally disposed between the lens element closest to the image side of the photographing lens system along the optical path and the image surface for correction of aberrations such as field curvature. The optical properties of the image correction unit, such as curvature, thickness, index of refraction, position and surface shape (convex or concave surface with spherical, aspheric, diffractive or Fresnel types), can be adjusted according to the design of the image capturing unit. In general, a preferable image correction unit is, for example, a thin transparent element having a concave object-side surface and a planar image-side surface, and the thin transparent element is disposed near the image surface.

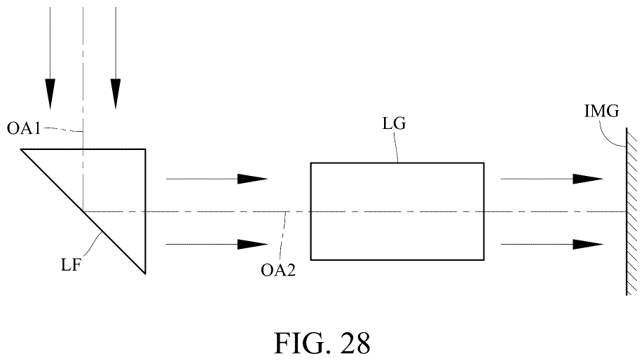

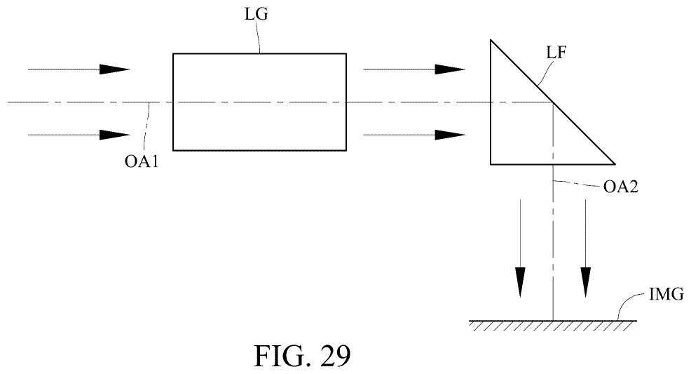

According to the present disclosure, at least one light-folding element, such as a prism or a mirror, can be optionally provided between an imaged object and the image surface on the imaging optical path, and the surface shape of the prism or mirror can be planar, spherical, aspheric or freeform, such that the photographing lens system can be more flexible in space arrangement, so that the miniaturization of an electronic device is not restricted by the total track length of the photographing lens system. Specifically, please refer to FIG. 28 and FIG. 29. FIG. 28 shows a schematic view of a configuration of one light-folding element in a photographing lens system according to one embodiment of the present disclosure, and FIG. 29 shows a schematic view of another configuration of one light-folding element in a photographing lens system according to one embodiment of the present disclosure.

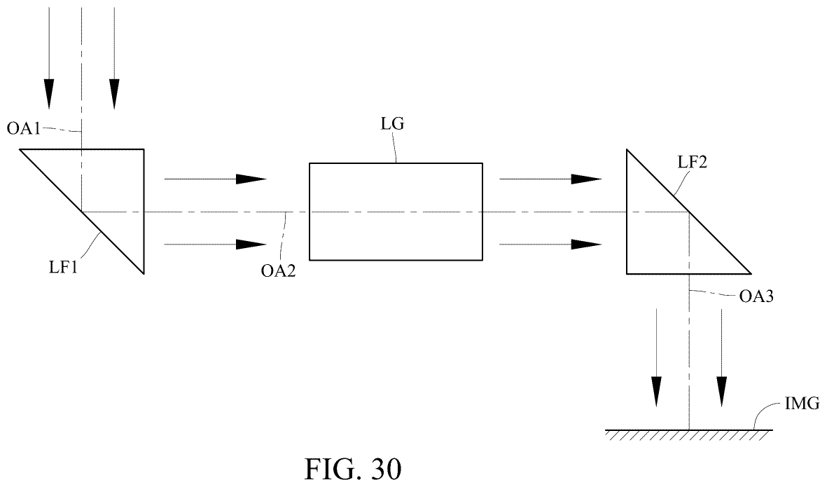

In FIG. 28 and FIG. 29, the photographing lens system can have, in order from an imaged object (not shown in the figures) to an image surface IMG along an optical path, a first optical axis OA1, a light-folding element LF and a second optical axis OA2. The light-folding element LF can be disposed between the imaged object and a lens group LG of the photographing lens system as shown in FIG. 28, or disposed between a lens group LG and the image surface IMG of the photographing lens system as shown in FIG. 29. Furthermore, please refer to FIG. 30, which shows a schematic view of a configuration of two light-folding elements in a photographing lens system according to one embodiment of the present disclosure. In FIG. 30, the photographing lens system can have, in order from an imaged object (not shown in the figure) to an image surface IMG along an optical path, a first optical axis OA1, a first light-folding element LF1, a second optical axis OA2, a second light-folding element LF2 and a third optical axis OA3. The first light-folding element LF1 is disposed between the imaged object and a lens group LG of the photographing lens system, the second light-folding element LF2 is disposed between the lens group LG and the image surface IMG of the photographing lens system, and the travelling direction of light along the first optical axis OA1 can be the same direction as the travelling direction of light along the third optical axis OA3 as shown in FIG. 30. The photographing lens system can be optionally provided with three or more light-folding elements, and the present disclosure is not limited to the types, numbers, or positions of the light-folding elements of the embodiments disclosed in the aforementioned figures.

According to the present disclosure, the photographing lens system can include at least one stop, such as an aperture stop, a glare stop or a field stop. Said glare stop or said field stop can be disposed between an imaged object and the first lens element, between adjacent lens elements, or between the last lens element and the image surface, and is set for eliminating the stray light and thereby improving image quality thereof.

According to the present disclosure, an aperture stop can be configured as a front stop or a middle stop. Afront stop disposed between an imaged object and the first lens element can provide a longer distance between an exit pupil of the photographing lens system and the image surface to produce a telecentric effect, and thereby improves the image-sensing efficiency of an image sensor (for example, CCD or CMOS). A middle stop disposed between the first lens element and the image surface is favorable for enlarging the viewing angle of the photographing lens system and thereby provides a wider field of view for the same.

According to the present disclosure, the photographing lens system can include an aperture control unit. The aperture control unit may be a mechanical component or a light modulator, which can control the size and shape of the aperture through electricity or electrical signals. The mechanical component can include a movable member, such as a blade assembly or a light shielding sheet. The light modulator can include a shielding element, such as a filter, an electrochromic material or a liquid-crystal layer. The aperture control unit controls the amount of incident light or exposure time to enhance the capability of image quality adjustment.

In addition, the aperture control unit can be the aperture stop of the present disclosure, which changes the f-number to obtain different image effects, such as the depth of field or lens speed.

According to the present disclosure, the photographing lens system can include one or more optical elements for limiting the form of light passing through the photographing lens system. Each optical element can be, but not limited to, a filter, a polarizer, etc., and each optical element can be, but not limited to, a single-piece element, a composite component, a thin film, etc. The optical element can be located at the object side or the image side of the photographing lens system or between any two adjacent lens elements so as to allow light in a specific form to pass through, thereby meeting application requirements.

According to the present disclosure, the photographing lens system can include at least one optical lens element, an optical element, or a carrier, which has at least one surface with a low reflection layer. The low reflection layer can effectively reduce stray light generated due to light reflection at the interface. The low reflection layer can be disposed in an optical non-effective area of an object-side surface or an image-side surface of the said optical lens element, or a connection surface between the object-side surface and the image-side surface. The said optical element can be a light-blocking element, an annular spacer, a barrel element, a cover glass, a blue glass, a filter, a color filter, an optical path folding element (e.g., a reflective element), a prism, a mirror, etc. The said carrier can be a base for supporting a lens assembly, a micro lens disposed on an image sensor, a substrate surrounding the image sensor, a glass plate for protecting the image sensor, etc.

According to the present disclosure, the photographing lens system can further include a light-blocking element. The light-blocking element can have a non-circular opening, and the non-circular opening can have different effective radii in different directions which are perpendicular to the optical axis. Therefore, it is favorable for the light-blocking element to coordinate with the shape of non-circular lens elements or aperture stop so as to reduce the size of the photographing lens system and make full use of the light passing through said non-circular lens elements or aperture stop, thereby reducing stray light. Moreover, the light-blocking element can be provided with a wavy structure or a jagged structure at a periphery of an inner hole portion thereof.

According to the present disclosure, the object side and image side are defined in accordance with the direction of the optical axis, and the axial optical data are calculated along the optical axis. Furthermore, if the optical axis is deflected by a reflective element, the axial optical data are also calculated along the deflected optical axis.

According to the above description of the present disclosure, the following specific embodiments are provided for further explanation.

### 1st Embodiment

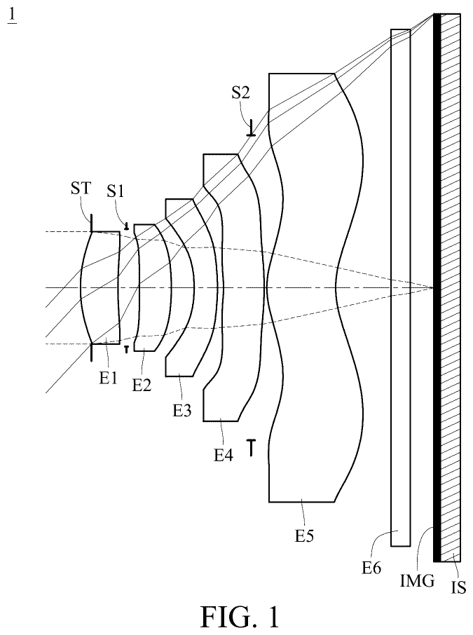

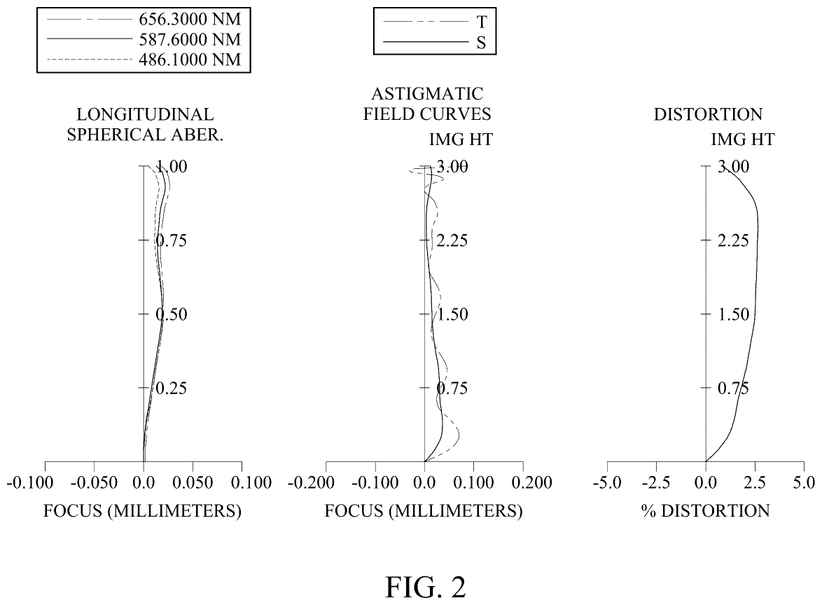

FIG. 1 is a schematic view of an image capturing unit according to the 1st embodiment of the present disclosure. FIG. 2 shows, in order from left to right, spherical aberration curves, astigmatic field curves and a distortion curve of the image capturing unit according to the 1st embodiment. In FIG. 1, the image capturing unit 1 includes the photographing lens system (its reference numeral is omitted) of the present disclosure and an image sensor IS. The photographing lens system includes, in order from an object side to an image side along an optical path, an aperture stop ST, a first lens element E1, a stop S1, a second lens element E2, a third lens element E3, a fourth lens element E4, a stop S2, a fifth lens element E5, a filter E6 and an image surface IMG. The photographing lens system includes five lens elements (E1, E2, E3, E4 and E5) with no additional lens element disposed between each of the adjacent five lens elements.

The first lens element E1 with positive refractive power has an object-side surface being convex in a paraxial region thereof and an image-side surface being concave in a paraxial region thereof. The first lens element E1 is made of plastic material and has the object-side surface and the image-side surface being both aspheric. The object-side surface of the first lens element E1 has one inflection point.

The image-side surface of the first lens element E1 has one inflection point. The image-side surface of the first lens element E1 has one critical point in an off-axis region thereof.

The second lens element E2 with positive refractive power has an object-side surface being concave in a paraxial region thereof and an image-side surface being convex in a paraxial region thereof. The second lens element E2 is made of plastic material and has the object-side surface and the image-side surface being both aspheric.

The third lens element E3 with negative refractive power has an object-side surface being concave in a paraxial region thereof and an image-side surface being convex in a paraxial region thereof. The third lens element E3 is made of plastic material and has the object-side surface and the image-side surface being both aspheric. The image-side surface of the third lens element E3 has one inflection point.

The fourth lens element E4 with negative refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has three inflection points. The image-side surface of the fourth lens element E4 has four inflection points. The object-side surface of the fourth lens element E4 has two critical points in an off-axis region thereof.

The fifth lens element E5 with positive refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has two inflection points. The object-side surface of the fifth lens element E5 has two critical points in an off-axis region thereof. The image-side surface of the fifth lens element E5 has one critical point in an off-axis region thereof.

The filter E6 is made of glass material and located between the fifth lens element E5 and the image surface IMG, and does not affect the focal length of the photographing lens system. The image sensor IS is disposed on or near the image surface IMG of the photographing lens system.

An average central thickness of the first lens element E1 to the fifth lens element E5 in the photographing lens system is 0.44 mm.

The equation of the aspheric surface profiles of the aforementioned lens elements of the 1st embodiment is expressed as follows:

$$X ( Y ) = ( {Y}^{2} / R ) / ( 1 + sqrt ( 1 - ( 1 + k ) \times {( Y / R )}^{2} ) ) + {\sum }_{i} ( Ai ) \times ( {Y}^{i} ) ,$$

where,
X is the displacement in parallel with an optical axis from an axial vertex on the aspheric surface to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient, and in the embodiments, i may be, but is not limited to, 4, 6, 8, 10, 12, 14, 16, 18, 20, 22, 24, 26, 28 and 30.

In the photographing lens system of the image capturing unit 1 according to the 1st embodiment, when a focal length of the photographing lens system is f, an f-number of the photographing lens system is Fno, and half of a maximum field of view of the photographing lens system is HFOV, these parameters have the following values: f=2.75 millimeters (mm), Fno=2.23, and HFOV=47.2 degrees (deg.).

When the maximum field of view of the photographing lens system is FOV, the following condition is satisfied: FOV=94.4 degrees.

When an Abbe number of the third lens element E3 is V3, and an Abbe number of the fourth lens element E4 is V4, the following condition is satisfied: V3+V4=39.9.

When the Abbe number of the third lens element E3 is V3, and the Abbe number of the fourth lens element E4 is V4, the following condition is satisfied: V4-V3=0.9.

When the Abbe number of the fourth lens element E4 is V4, and an Abbe number of the fifth lens element E5 is V5, the following condition is satisfied: V4/V5=0.36.

When the Abbe number of the fourth lens element E4 is V4, and the Abbe number of the fifth lens element E5 is V5, the following condition is satisfied: V5-V4=35.6.

When an Abbe number of the first lens element E1 is V1, and an Abbe number of the second lens element E2 is V2, the following condition is satisfied: V1+V2=112.1.

When the Abbe number of the second lens element E2 is V2, and the Abbe number of the third lens element E3 is V3, the following condition is satisfied: V2-V3=36.5.

When a central thickness of the first lens element E1 is CT1, a central thickness of the second lens element E2 is CT2, a central thickness of the third lens element E3 is CT3, and a central thickness of the fourth lens element E4 is CT4, the following condition is satisfied: CT1/[(CT2+CT3+CT4)/3]=1.17.

When a sum of central thicknesses of all lens elements of the photographing lens system is ΣCT, and a sum of axial distances between each of all adjacent lens elements of the photographing lens system is ZAT, the following condition is satisfied: ΣCT/ΣAT=3.82. In this embodiment, ICT is a sum of central thicknesses of the first lens element E1, the second lens element E2, the third lens element E3, the fourth lens element E4 and the fifth lens element E5. In this embodiment, IAT is a sum of axial distances between any two adjacent lens elements among the first lens element E1, the second lens element E2, the third lens element E3, the fourth lens element E4 and the fifth lens element E5. In this embodiment, an axial distance between two adjacent lens elements is a distance in a paraxial region between two adjacent lens surfaces of the two adjacent lens elements.

When a curvature radius of the object-side surface of the third lens element E3 is R5, and an axial distance between the object-side surface of the third lens element E3 and the image surface IMG is Dr5I, the following condition is satisfied: R5/Dr5I=−0.51.

When a curvature radius of the image-side surface of the third lens element E3 is R6, and an axial distance between the image-side surface of the third lens element E3 and the image surface IMG is Dr6I, the following condition is satisfied: R6/Dr6I=−0.63.

When the focal length of the photographing lens system is f, and the curvature radius of the object-side surface of the third lens element E3 is R5, the following condition is satisfied: f/R5=−2.05.

When the focal length of the photographing lens system is f, and the curvature radius of the image-side surface of the third lens element E3 is R6, the following condition is satisfied: f/R6=−1.83.

When the focal length of the photographing lens system is f, and a focal length of the fifth lens element E5 is f5, the following condition is satisfied: f/f5=0.79.

When a focal length of the first lens element E1 is f1, and a focal length of the second lens element E2 is f2, the following condition is satisfied: f1/f2=0.79.

When a focal length of the fourth lens element E4 is f4, and the focal length of the fifth lens element E5 is f5, the following condition is satisfied: f5/f4=−1.14.

When the focal length of the first lens element E1 is f1, and a focal length of the third lens element E3 is f3, the following condition is satisfied: |f1/f3|=0.07.

When the focal length of the second lens element E2 is f2, and the focal length of the third lens element E3 is f3, the following condition is satisfied: |f2/f3|=0.09.

When the focal length of the third lens element E3 is f3, and the focal length of the fourth lens element E4 is f4, the following condition is satisfied: |f4/f3|=0.06.

When the focal length of the photographing lens system is f, the focal length of the third lens element E3 is f3, and the focal length of the fifth lens element E5 is f5, the following condition is satisfied: |f5/f3|=0.06.

When the focal length of the fourth lens element E4 is f4, the focal length of the fifth lens element E5 is f5, and the focal length of the photographing lens system is f, the following condition is satisfied: |f4/f|+|f5/f|=2.37.

When the focal length of the photographing lens system is f, and a composite focal length of the second lens element E2, the third lens element E3, the fourth lens element E4 and the fifth lens element E5 is f2345, the following condition is satisfied: f/f2345=0.30.

When a composite focal length of the second lens element E2 and the third lens element E3 is f23, and the focal length of the photographing lens system is f, the following condition is satisfied: f23/f=2.11.

When an axial distance between the object-side surface of the first lens element E1 and the image surface IMG is TL, and a maximum image height of the photographing lens system is ImgH, the following condition is satisfied: TL/ImgH=1.29.

When the axial distance between the object-side surface of the first lens element E1 and the image surface IMG is TL, and the focal length of the photographing lens system is f, the following condition is satisfied: TL/f=1.41.

The detailed optical data of the 1st embodiment are shown in Table 1A and the aspheric surface data are shown in Table 1B below.

TABLE 1A
1st Embodiment
f = 2.75 mm, Fno = 2.23, HFOV = 47.2 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Ape. Stop | Plano | | −0.120 | | | | |
| 2 | Lens 1 | 1.4300 | (ASP) | 0.411 | Plastic | 1.545 | 56.1 | 3.90 |
| 3 | | 3.9193 | (ASP) | 0.093 | | | | |
| 4 | Stop | Plano | | 0.142 | | | | |
| 5 | Lens 2 | −200.0000 | (ASP) | 0.350 | Plastic | 1.544 | 56.0 | 4.92 |
| 6 | | −2.6407 | (ASP) | 0.250 | | | | |
| 7 | Lens 3 | −1.3413 | (ASP) | 0.256 | Plastic | 1.669 | 19.5 | −55.04 |
| 8 | | −1.4985 | (ASP) | 0.066 | | | | |
| 9 | Lens 4 | −1.1247 | (ASP) | 0.445 | Plastic | 1.660 | 20.4 | −3.05 |
| 10 | | −2.9526 | (ASP) | −0.143 | | | | |
| 11 | Stop | Plano | | 0.172 | | | | |
| 12 | Lens 5 | 0.8126 | (ASP) | 0.754 | Plastic | 1.544 | 56.0 | 3.48 |
| 13 | | 0.9589 | (ASP) | 0.607 | | | | |

| | | | | | | | |
|---|---|---|---|---|---|---|---|
| 14 | Filter | Plano | 0.210 | Glass | 1.517 | 64.2 | — |
| 15 | | Plano | 0.260 | | | | |
| 16 | Image | Plano | — | | | | |

Note:
Reference wavelength is 587.6 nm (d-line).
An effective radius of the stop S1 (Surface 4) is 0.644 mm.
An effective radius of the stop S2 (Surface 11) is 1.672 mm.

TABLE 1B
Aspheric Coefficients

| Surface # | 2 | 3 | 5 | 6 |
|---|---|---|---|---|
| k= | 1.28773E+00 | −7.24804E+00 | −9.89775E+01 | 0.00000E+00 |
| A4= | −4.803906232E−02 | −1.349740706E−01 | −3.767734632E−01 | −4.984950547E−01 |
| A6= | −2.240534427E+00 | 1.404307343E+00 | 6.167849866E+00 | 3.864486741E+00 |
| A8= | 7.957020291E+01 | −3.981620124E+01 | −1.815197671E+02 | −7.117291763E+01 |
| A10= | −1.843568441E+03 | 6.307306096E+02 | 3.198479075E+03 | 8.532043585E+02 |
| A12= | 2.781474105E+04 | −6.738751843E+03 | −3.829369159E+04 | −7.056025583E+03 |
| A14= | −2.859672924E+05 | 4.971179281E+04 | 3.230097977E+05 | 4.097195839E+04 |
| A16= | 2.061241252E+06 | −2.617444376E+05 | −1.965201831E+06 | −1.687929811E+05 |
| A18= | −1.057472450E+07 | 1.016577357E+06 | 8.723647954E+06 | 4.944494180E+05 |
| A20= | 3.872514665E+07 | −3.000376936E+06 | −2.827630222E+07 | −1.020829827E+06 |
| A22= | −1.002160957E+08 | 6.834033053E+06 | 6.619407838E+07 | 1.449347491E+06 |
| A24= | 1.784183906E+08 | −1.180409451E+07 | −1.089644238E+08 | −1.344631875E+06 |
| A26= | −2.070335756E+08 | 1.446738013E+07 | 1.196495348E+08 | 7.326564991E+05 |
| A28= | 1.402097948E+08 | −1.099951184E+07 | −7.868775884E+07 | −1.774453037E+05 |
| A30= | −4.172735183E+07 | 3.824358439E+06 | 2.344822444E+07 | — |

| Surface # | 7 | 8 | 9 | 10 |
|---|---|---|---|---|
| k= | −1.20288E+00 | −8.04109E+00 | −5.69137E+00 | −1.86799E+00 |
| A4= | −1.256541844E−01 | 3.328887792E+00 | 5.044373487E+00 | 4.817654257E−01 |
| A6= | −1.432927305E+01 | −4.415310284E+01 | −4.517784611E+01 | −4.501526032E+00 |
| A8= | 1.734543343E+02 | 3.466957825E+02 | 2.960314844E+02 | 3.039706316E+01 |
| A10= | −1.158092422E+03 | −1.907791691E+03 | −1.425283468E+03 | −1.134836488E+02 |
| A12= | 4.094495591E+03 | 7.449109307E+03 | 5.007547157E+03 | 2.650206448E+02 |
| A14= | −2.177954033E+02 | −2.085387389E+04 | −1.297523609E+04 | −4.202818296E+02 |
| A16= | −7.632025489E+04 | 4.225206937E+04 | 2.504736445E+04 | 4.727950161E+02 |
| A18= | 4.256142308E+05 | −6.205426771E+04 | −3.614751428E+04 | −3.853834385E+02 |
| A20= | −1.312715326E+06 | 6.540120706E+04 | 3.879355699E+04 | 2.289092957E+02 |
| A22= | 2.626521301E+06 | −4.818049697E+04 | −3.046516733E+04 | −9.825886039E+01 |
| A24= | −3.496177559E+06 | 2.353408193E+04 | 1.696836668E+04 | 2.972335758E+01 |
| A26= | 3.002990262E+06 | −6.840329776E+03 | −6.333184001E+03 | −6.016393606E+00 |
| A28= | −1.511281078E+06 | 8.943672860E+02 | 1.417244295E+03 | 7.319164577E−01 |
| A30= | 3.392315337E+05 | — | −1.434380240E+02 | −4.048020449E−02 |

| Surface # | 12 | 13 |
|---|---|---|
| k= | −1.00000E+00 | −1.02137E+00 |
| A4= | −1.367071671E+00 | −5.500605152E−01 |
| A6= | 2.905417292E+00 | 5.785442419E−01 |
| A8= | −4.696109584E+00 | −5.166471631E−01 |
| A10= | 5.080913024E+00 | 3.412768881E−01 |
| A12= | −3.685606061E+00 | −1.645542285E−01 |
| A14= | 1.804637913E+00 | 5.858747687E−02 |
| A16= | −5.911435263E−01 | −1.556088979E−02 |
| A18= | 1.249140222E−01 | 3.075025058E−03 |
| A20= | −1.540511653E−02 | −4.410378781E−04 |
| A22= | 7.595510242E−04 | 4.331356728E−05 |
| A24= | 3.768409601E−05 | −2.588443818E−06 |
| A26= | −4.574163084E−06 | 7.042011108E−08 |

In Table 1A, the curvature radius, the thickness and the focal length are shown in millimeters (mm). Surface numbers 0-16 represent the surfaces sequentially arranged from the object side to the image side along the optical axis. In Table 1B, k represents the conic coefficient of the equation of the aspheric surface profiles. A4-A30 represent the aspheric coefficients ranging from the 4th order to the 30th order.

The tables presented below for each embodiment are the corresponding schematic parameter and aberration curves, and the definitions of the tables are the same as Table 1A and Table 1B of the 1st embodiment. Therefore, an explanation in this regard will not be provided again.

### 2nd Embodiment

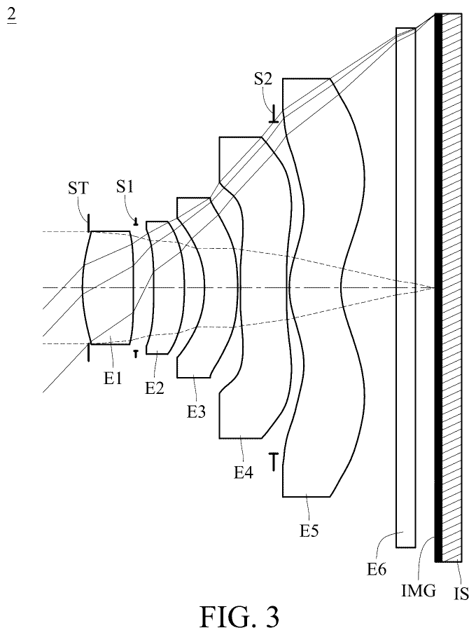

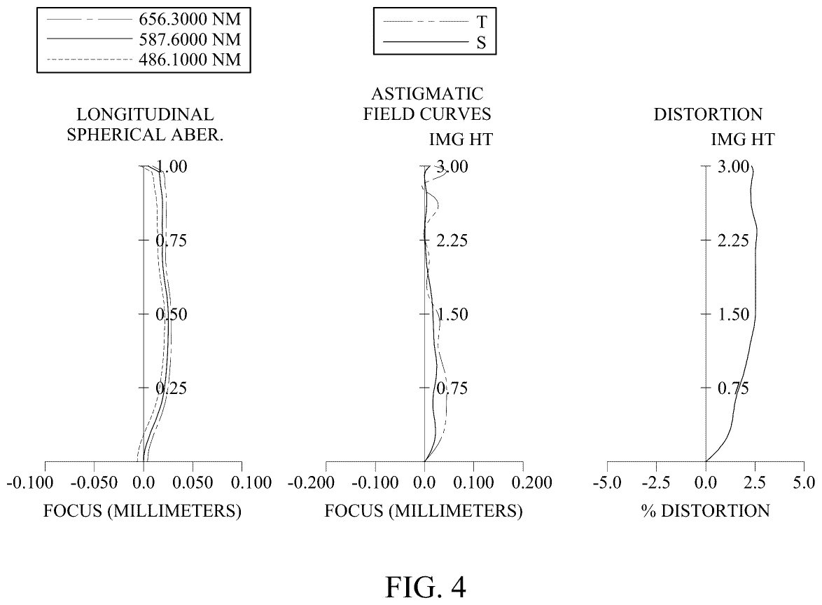

FIG. 3 is a schematic view of an image capturing unit according to the 2nd embodiment of the present disclosure. FIG. 4 shows, in order from left to right, spherical aberration curves, astigmatic field curves and a distortion curve of the image capturing unit according to the 2nd embodiment. In FIG. 3, the image capturing unit 2 includes the photographing lens system (its reference numeral is omitted) of the present disclosure and an image sensor IS. The photographing lens system includes, in order from an object side to an image side along an optical path, an aperture stop ST, a first lens element E1, a stop S1, a second lens element E2, a third lens element E3, a fourth lens element E4, a stop S2, a fifth lens element E5, a filter E6 and an image surface IMG. The photographing lens system includes five lens elements (E1, E2, E3, E4 and E5) with no additional lens element disposed between each of the adjacent five lens elements.

The first lens element E1 with positive refractive power has an object-side surface being convex in a paraxial region thereof and an image-side surface being convex in a paraxial region thereof. The first lens element E1 is made of plastic material and has the object-side surface and the image-side surface being both aspheric. The object-side surface of the first lens element E1 has one inflection point.

The second lens element E2 with positive refractive power has an object-side surface being concave in a paraxial region thereof and an image-side surface being convex in a paraxial region thereof. The second lens element E2 is made of plastic material and has the object-side surface and the image-side surface being both aspheric.

The third lens element E3 with negative refractive power has an object-side surface being concave in a paraxial region thereof and an image-side surface being convex in a paraxial region thereof. The third lens element E3 is made of plastic material and has the object-side surface and the image-side surface being both aspheric. The image-side surface of the third lens element E3 has one inflection point.

The fourth lens element E4 with negative refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has three inflection points. The image-side surface of the fourth lens element E4 has five inflection points. The object-side surface of the fourth lens element E4 has two critical points in an off-axis region thereof. The image-side surface of the fourth lens element E4 has two critical points in an off-axis region thereof.

The fifth lens element E5 with positive refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has six inflection points. The image-side surface of the fifth lens element E5 has three inflection points. The object-side surface of the fifth lens element E5 has one critical point in an off-axis region thereof. The image-side surface of the fifth lens element E5 has one critical point in an off-axis region thereof.

The filter E6 is made of glass material and located between the fifth lens element E5 and the image surface IMG, and does not affect the focal length of the photographing lens system. The image sensor IS is disposed on or near the image surface IMG of the photographing lens system.

An average central thickness of the first lens element E1 to the fifth lens element E5 in the photographing lens system is 0.47 mm. Moreover, a central thickness of the first lens element E1 is 0.559 mm, and the central thickness (0.559 mm) of the first lens element E1 is larger than the average central thickness (0.47 mm) of all lens elements in the photographing lens system.

The detailed optical data of the 2nd embodiment are shown in Table 2A and the aspheric surface data are shown in Table 2B below.

TABLE 2A
2nd Embodiment
f = 2.74 mm, Fno = 2.23, HFOV = 46.8 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Ape. Stop | Plano | | −0.068 | | | | |
| 2 | Lens 1 | 1.7312 | (ASP) | 0.559 | Plastic | 1.545 | 56.1 | 3.08 |
| 3 | | −50.0000 | (ASP) | 0.026 | | | | |
| 4 | Stop | Plano | | 0.197 | | | | |
| 5 | Lens 2 | −9.6895 | (ASP) | 0.336 | Plastic | 1.544 | 56.0 | 8.06 |
| 6 | | −3.0546 | (ASP) | 0.221 | | | | |
| 7 | Lens 3 | −1.3397 | (ASP) | 0.365 | Plastic | 1.686 | 18.4 | −54.43 |
| 8 | | −1.5436 | (ASP) | 0.030 | | | | |
| 9 | Lens 4 | −2.9913 | (ASP) | 0.506 | Plastic | 1.669 | 19.5 | −5.54 |
| 10 | | −16.6087 | (ASP) | −0.142 | | | | |
| 11 | Stop | Plano | | 0.171 | | | | |
| 12 | Lens 5 | 0.8698 | (ASP) | 0.566 | Plastic | 1.544 | 56.0 | 8.84 |
| 13 | | 0.8184 | (ASP) | 0.607 | | | | |

| | | | | | | | |
|---|---|---|---|---|---|---|---|
| 14 | Filter | Plano | 0.210 | Glass | 1.517 | 64.2 | — |
| 15 | | Plano | 0.219 | | | | |
| 16 | Image | Plano | — | | | | |

Note:
Reference wavelength is 587.6 nm (d-line).
An effective radius of the stop S1 (Surface 4) is 0.691 mm.
An effective radius of the stop S2 (Surface 11) is 1.817 mm.

TABLE 2B
Aspheric Coefficients

| Surface # | 2 | 3 | 5 | 6 |
|---|---|---|---|---|
| k= | 1.34954E+00 | 0.00000E+00 | −4.19381E+01 | 0.00000E+00 |
| A4= | −1.420244393E−01 | −7.229767963E−02 | −4.325420192E−01 | −7.149458794E−01 |
| A6= | 2.645759734E+00 | −5.487037659E+00 | 7.262606374E−01 | 5.994580926E+00 |
| A8= | −8.715877290E+01 | 1.109643240E+02 | 2.139806969E+01 | −9.186814918E+01 |
| A10= | 1.751799197E+03 | −1.418724802E+03 | −7.617903398E+02 | 9.982635458E+02 |
| A12= | −2.382766479E+04 | 1.188985126E+04 | 1.126262080E+04 | −7.421582691E+03 |
| A14= | 2.269243435E+05 | −6.757291284E+04 | −1.015618698E+05 | 3.848838936E+04 |
| A16= | −1.544571930E+06 | 2.644616169E+05 | 6.173128133E+05 | −1.409930599E+05 |
| A18= | 7.590251558E+06 | −7.120507741E+05 | −2.630916101E+06 | 3.663527697E+05 |
| A20= | −2.694529430E+07 | 1.293107087E+06 | 7.973719409E+06 | −6.702852937E+05 |
| A22= | 6.839460726E+07 | −1.509654101E+06 | −1.712491776E+07 | 8.432206862E+05 |
| A24= | −1.210176591E+08 | 1.020270576E+06 | 2.548971687E+07 | −6.933267786E+05 |
| A26= | 1.418587098E+08 | −3.023665697E+05 | −2.501445488E+07 | 3.350101282E+05 |
| A28= | −9.913908167E+07 | — | 1.455704267E+07 | −7.202644436E+04 |
| A30= | 3.133491184E+07 | — | −3.804358474E+06 | — |

| Surface # | 7 | 8 | 9 | 10 |
|---|---|---|---|---|
| k= | −1.99120E+00 | 0.00000E+00 | 2.86317E−01 | −9.90000E+01 |
| A4= | −7.194400336E−01 | 3.445603301E+00 | 4.917221415E+00 | 1.066990190E+00 |
| A6= | −4.384415227E+00 | −4.666285274E+01 | −4.822914822E+01 | −4.791467276E+00 |
| A8= | 1.006932076E+02 | 3.606405398E+02 | 3.169889469E+02 | 1.448147246E+01 |
| A10= | −9.520460658E+02 | −1.933406504E+03 | −1.499132720E+03 | −3.140944299E+01 |
| A12= | 5.600071169E+03 | 7.459132121E+03 | 5.173068111E+03 | 4.846678138E+01 |
| A14= | −2.193068549E+04 | −2.092170141E+04 | −1.314673935E+04 | −5.394147889E+01 |
| A16= | 5.875141540E+04 | 4.281949437E+04 | 2.474756125E+04 | 4.400387743E+01 |
| A18= | −1.082516705E+05 | −6.373836576E+04 | −3.452862431E+04 | −2.656156602E+01 |
| A20= | 1.349202008E+05 | 6.810319224E+04 | 3.548530878E+04 | 1.187082007E+01 |
| A22= | −1.086075140E+05 | −5.079351102E+04 | −2.644202462E+04 | −3.890527514E+00 |
| A24= | 5.093158946E+04 | 2.506638919E+04 | 1.386156599E+04 | 9.128060302E−01 |
| A26= | −1.056353798E+04 | −7.344683402E+03 | −4.836736119E+03 | −1.458621915E−01 |
| A28= | — | 9.661012338E+02 | 1.006535007E+03 | 1.427829600E−02 |
| A30= | — | — | −9.435641326E+01 | −6.474280416E−04 |

| Surface # | 12 | 13 |
|---|---|---|
| k= | −1.00000E+00 | −1.08598E+00 |
| A4= | −5.663846170E−01 | −7.623703849E−01 |
| A6= | −1.146061512E+00 | 8.177327944E−01 |
| A8= | 5.613025152E+00 | −6.414666859E−01 |
| A10= | −1.103117412E+01 | 3.093400372E−01 |
| A12= | 1.269286861E+01 | −6.441114367E−02 |
| A14= | −9.351546671E+00 | −1.838988137E−02 |
| A16= | 4.589112296E+00 | 1.840789261E−02 |
| A18= | −1.520103701E+00 | −6.535537146E−03 |
| A20= | 3.364098050E−01 | 1.325633859E−03 |
| A22= | −4.773419115E−02 | −1.604455990E−04 |
| A24= | 3.931382547E−03 | 1.078123793E−05 |
| A26= | −1.430275414E−04 | −3.096108207E−07 |

In the 2nd embodiment, the equation of the aspheric surface profiles of the aforementioned lens elements is the same as the equation of the 1st embodiment. Also, the definitions of these parameters shown in Table 20 below are the same as those stated in the 1st embodiment, with corresponding values for the 2nd embodiment; therefore, an explanation in this regard will not be provided again.

Moreover, these parameters can be calculated from Table 2A and Table 2B3 as the following values and satisfy the following conditions:

TABLE 2C
Values of Optical and Physical Parameters/Definitions

| | | | |
|---|---|---|---|
| f [mm] | 2.74 | f/R5 | −2.05 |
| Fno | 2.23 | f/R6 | −1.78 |
| HFOV [deg.] | 46.8 | f/f5 | 0.31 |
| FOV [deg.] | 93.6 | f1/f2 | 0.38 |
| V3 + V4 | 37.9 | f5/f4 | −1.60 |
| V4 − V3 | 1.1 | \|f1/f3\| | 0.06 |
| V4/V5 | 0.35 | \|f2/f3\| | 0.15 |
| V5 − V4 | 36.5 | \|f4/f3\| | 0.10 |
| V1 + V2 | 112.1 | \|f5/f3\| | 0.16 |
| V2 − V3 | 37.6 | \|f4/f\| + \|f5/f\| | 5.24 |
| CT1/[(CT2 + CT3 + CT4)/3] | 1.39 | f/f2345 | 0.01 |
| ΣCT/ΣAT | 4.64 | f23/f | 3.87 |
| R5/Dr5I | −0.53 | TL/ImgH | 1.29 |
| R6/Dr6I | −0.71 | TL/f | 1.41 |

### 3rd Embodiment

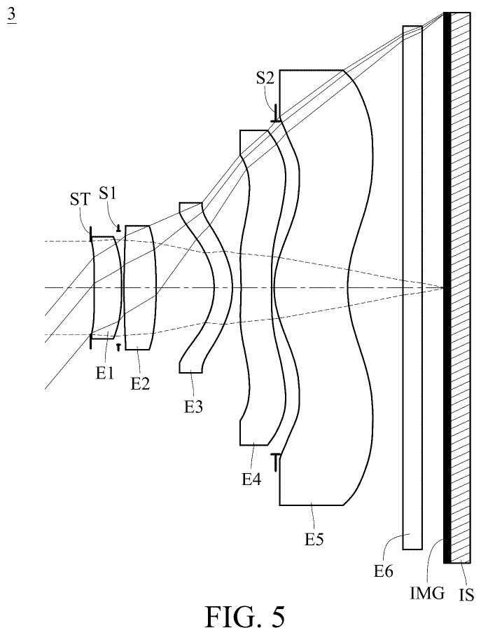

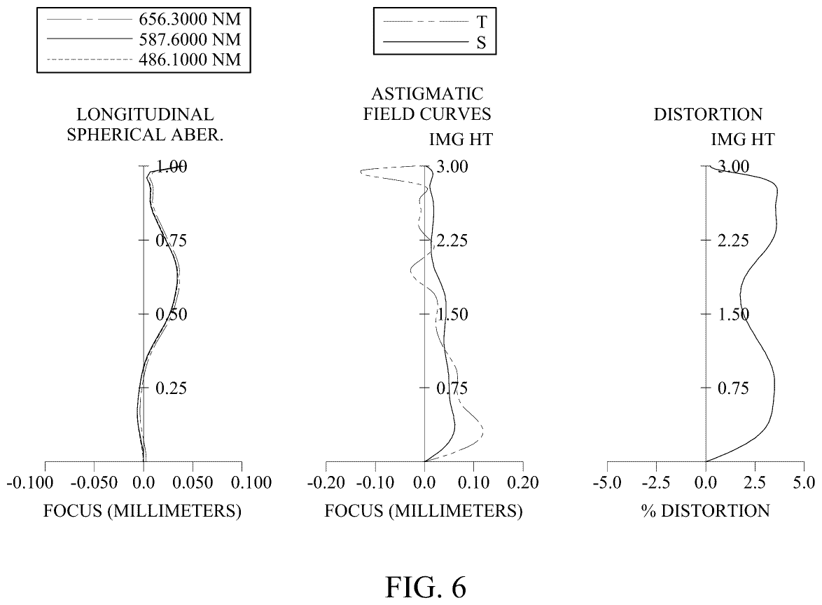

FIG. 5 is a schematic view of an image capturing unit according to the 3rd embodiment of the present disclosure. FIG. 6 shows, in order from left to right, spherical aberration curves, astigmatic field curves and a distortion curve of the image capturing unit according to the 3rd embodiment. In FIG. 5, the image capturing unit 3 includes the photographing lens system (its reference numeral is omitted) of the present disclosure and an image sensor IS. The photographing lens system includes, in order from an object side to an image side along an optical path, an aperture stop ST, a first lens element E1, a stop S1, a second lens element E2, a third lens element E3, a fourth lens element E4, a stop S2, a fifth lens element E5, a filter E6 and an image surface IMG. The photographing lens system includes five lens elements (E1, E2, E3, E4 and E5) with no additional lens element disposed between each of the adjacent five lens elements.

The first lens element E1 with positive refractive power has an object-side surface being concave in a paraxial region thereof and an image-side surface being convex in a paraxial region thereof. The first lens element E1 is made of plastic material and has the object-side surface and the image-side surface being both aspheric.

The second lens element E2 with positive refractive power has an object-side surface being convex in a paraxial region thereof and an image-side surface being convex in a paraxial region thereof. The second lens element E2 is made of plastic material and has the object-side surface and the image-side surface being both aspheric. The object-side surface of the second lens element E2 has three inflection points.

The third lens element E3 with negative refractive power has an object-side surface being concave in a paraxial region thereof and an image-side surface being convex in a paraxial region thereof. The third lens element E3 is made of plastic material and has the object-side surface and the image-side surface being both aspheric. The object-side surface of the third lens element E3 has one inflection point.

The image-side surface of the third lens element E3 has one inflection point. The image-side surface of the third lens element E3 has one critical point in an off-axis region thereof.

The fourth lens element E4 with negative refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has three inflection points. The image-side surface of the fourth lens element E4 has three inflection points. The object-side surface of the fourth lens element E4 has two critical points in an off-axis region thereof. The image-side surface of the fourth lens element E4 has two critical points in an off-axis region thereof.

The fifth lens element E5 with positive refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has four inflection points. The image-side surface of the fifth lens element E5 has two inflection points. The object-side surface of the fifth lens element E5 has one critical point in an off-axis region thereof. The image-side surface of the fifth lens element E5 has one critical point in an off-axis region thereof.

The filter E6 is made of glass material and located between the fifth lens element E5 and the image surface IMG, and does not affect the focal length of the photographing lens system. The image sensor IS is disposed on or near the image surface IMG of the photographing lens system.

An average central thickness of the first lens element E1 to the fifth lens element E5 in the photographing lens system is 0.40 mm.

The detailed optical data of the 3rd embodiment are shown in Table 3A and the aspheric surface data are shown in Table 3B below.

TABLE 3A
3rd Embodiment
f = 2.49 mm, Fno = 2.44, HFOV = 50.2 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Ape. Stop | Plano | | 0.040 | | | | |
| 2 | Lens 1 | −100.0000 | (ASP) | 0.300 | Plastic | 1.545 | 56.1 | 9.26 |
| 3 | | −4.8098 | (ASP) | −0.034 | | | | |
| 4 | Stop | Plano | | 0.059 | | | | |
| 5 | Lens 2 | 3.7364 | (ASP) | 0.354 | Plastic | 1.544 | 56.0 | 3.90 |
| 6 | | −4.7331 | (ASP) | 0.636 | | | | |
| 7 | Lens 3 | −0.7829 | (ASP) | 0.200 | Plastic | 1.705 | 14.0 | −46.64 |
| 8 | | −0.8867 | (ASP) | 0.095 | | | | |
| 9 | Lens 4 | −3.6773 | (ASP) | 0.334 | Plastic | 1.705 | 14.0 | −5.66 |
| 10 | | −49.1931 | (ASP) | 0.045 | | | | |
| 11 | Stop | Plano | | −0.016 | | | | |
| 12 | Lens 5 | 1.0098 | (ASP) | 0.806 | Plastic | 1.544 | 56.0 | 3.75 |
| 13 | | 1.4376 | (ASP) | 0.607 | | | | |

| | | | | | | | |
|---|---|---|---|---|---|---|---|
| 14 | Filter | Plano | 0.210 | Glass | 1.517 | 64.2 | — |
| 15 | | Plano | 0.239 | | | | |
| 16 | Image | Plano | — | | | | |

Note:
Reference wavelength is 587.6 nm (d-line).
An effective radius of the stop S1 (Surface 4) is 0.623 mm.
An effective radius of the stop S2 (Surface 11) is 1.825 mm.

TABLE 3B
Aspheric Coefficients

| Surface # | 2 | 3 | 5 | 6 |
|---|---|---|---|---|
| k= | −1.95399E−11 | 0.00000E+00 | 0.00000E+00 | 0.00000E+00 |
| A4= | −1.407694764E−01 | −1.502199341E+00 | −1.237507999E+00 | −9.258762338E−02 |
| A6= | −2.072752049E+01 | 5.601935938E+00 | 1.173785402E+01 | 1.869139543E+00 |
| A8= | 9.857448262E+02 | 5.000336965E+01 | −1.388560081E+02 | −4.926190508E+01 |
| A10= | −2.970781173E+04 | −1.569988950E+03 | 1.735442243E+03 | 7.121569602E+02 |
| A12= | 5.955640725E+05 | 1.983192794E+04 | −1.708565802E+04 | −6.607546513E+03 |
| A14= | −8.239649249E+06 | −1.539309069E+05 | 1.225918285E+05 | 4.110806669E+04 |
| A16= | 8.046104607E+07 | 7.884428743E+05 | −6.332332585E+05 | −1.759459166E+05 |
| A18= | −5.605702772E+08 | −2.703381016E+06 | 2.340365906E+06 | 5.239861781E+05 |
| A20= | 2.785491803E+09 | 6.112337067E+06 | −6.107001976E+06 | −1.082562055E+06 |
| A22= | −9.745901233E+09 | −8.688799498E+06 | 1.094589104E+07 | 1.519615631E+06 |
| A24= | 2.330188773E+10 | 6.973667348E+06 | −1.278139106E+07 | −1.380676084E+06 |
| A26= | −3.591810342E+10 | −2.378875067E+06 | 8.730492974E+06 | 7.311449055E+05 |
| A28= | 3.174153336E+10 | — | −2.639316096E+06 | −1.710586654E+05 |
| A30= | −1.195190257E+10 | — | — | — |

| Surface # | 7 | 8 | 9 | 10 |
|---|---|---|---|---|
| k= | −3.48157E+00 | −1.00000E+00 | 9.51668E−01 | 0.00000E+00 |
| A4= | −1.094627578E−02 | 6.438614563E−02 | 2.116276038E−01 | 1.084419254E+00 |
| A6= | −3.223307791E+01 | −1.276569398E+01 | 7.139540384E+00 | −3.992361166E+00 |
| A8= | 4.835574619E+02 | 1.887169499E+02 | −4.405207566E+01 | 1.129932307E+01 |
| A10= | −3.762088201E+03 | −1.246008658E+03 | 1.438382947E+02 | −2.333607087E+01 |
| A12= | 1.825731025E+04 | 4.856528445E+03 | −3.126204503E+02 | 3.289938212E+01 |
| A14= | −5.925884155E+04 | −1.240371227E+04 | 4.811264354E+02 | −3.160005883E+01 |
| A16= | 1.325550507E+05 | 2.174778009E+04 | −5.354817188E+02 | 2.092969545E+01 |
| A18= | −2.053565519E+05 | −2.660507361E+04 | 4.333154971E+02 | −9.609200871E+00 |
| A20= | 2.165251424E+05 | 2.260082132E+04 | −2.537431206E+02 | 3.030912261E+00 |
| A22= | −1.482464881E+05 | −1.299796212E+04 | 1.058754362E+02 | −6.378404298E−01 |
| A24= | 5.939821836E+04 | 4.793188234E+03 | −3.052070696E+01 | 8.418723948E−02 |
| A26= | −1.056353846E+04 | −1.013930433E+03 | 5.739000631E+00 | −6.139504424E−03 |
| A28= | — | 9.259652319E+01 | −6.279880901E−01 | 1.832169115E−04 |
| A30= | — | — | 2.995628355E−02 | −8.399555313E−07 |

| Surface # | 12 | 13 |
|---|---|---|
| k= | −1.00000E+00 | −6.90838E−01 |
| A4= | 1.720738681E−01 | −3.725652970E−03 |
| A6= | −2.410500220E+00 | −5.004619233E−01 |
| A8= | 6.321754973E+00 | 8.777125823E−01 |
| A10= | −9.511130978E+00 | −9.207540848E−01 |
| A12= | 8.879496714E+00 | 6.376644435E−01 |
| A14= | −5.211909344E+00 | −3.004945137E−01 |
| A16= | 1.866728191E+00 | 9.793286866E−02 |
| A18= | −3.518617014E−01 | −2.212408743E−02 |
| A20= | 5.001316720E−03 | 3.406537664E−03 |
| A22= | 1.303963930E−02 | −3.413377645E−04 |
| A24= | −2.827176091E−03 | 2.006169054E−05 |
| A26= | 2.516230956E−04 | −5.243278776E−07 |
| A28= | −8.263214545E−06 | — |
| A30= | 1.886178070E−08 | — |

In the 3rd embodiment, the equation of the aspheric surface profiles of the aforementioned lens elements is the same as the equation of the 1st embodiment. Also, the definitions of these parameters shown in Table 30 below are the same as those stated in the 1st embodiment, with corresponding values for the 3rd embodiment; therefore, an explanation in this regard will not be provided again.

Moreover, these parameters can be calculated from Table 3A and Table 3B3 as the following values and satisfy the following conditions:

TABLE 3C
Values of Optical and Physical Parameters/Definitions

| | | | |
|---|---|---|---|
| f [mm] | 2.49 | f/R5 | −3.18 |
| Fno | 2.44 | f/R6 | −2.81 |
| HFOV [deg.] | 50.2 | f/f5 | 0.66 |
| FOV [deg.] | 100.4 | f1/f2 | 2.38 |
| V3 + V4 | 28.0 | f5/f4 | −0.66 |
| V4 − V3 | 0.0 | \|f1/f3\| | 0.20 |
| V4/V5 | 0.25 | \|f2/f3\| | 0.08 |
| V5 − V4 | 42.0 | \|f4/f3\| | 0.12 |
| V1 + V2 | 112.1 | \|f5/f3\| | 0.08 |
| V2 − V3 | 42.0 | \|f4/f\| + \|f5/f\| | 3.78 |
| CT1/[(CT2 + CT3 + CT4)/3] | 1.01 | f/f2345 | 0.75 |
| ΣCT/ΣAT | 2.54 | f23/f | 1.86 |
| R5/Dr5I | −0.31 | TL/ImgH | 1.28 |
| R6/Dr6I | −0.38 | TL/f | 1.54 |

### 4th Embodiment

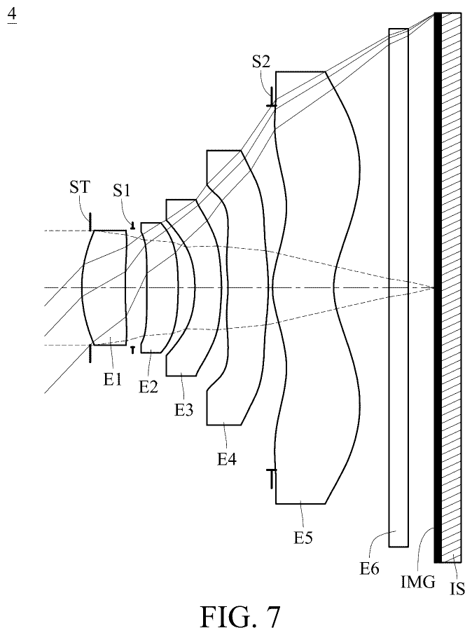

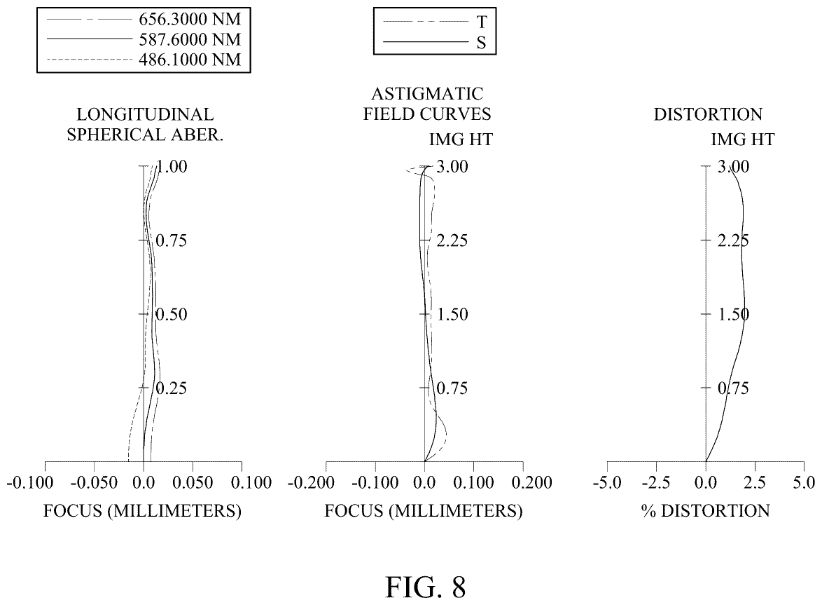

FIG. 7 is a schematic view of an image capturing unit according to the 4th embodiment of the present disclosure. FIG. 8 shows, in order from left to right, spherical aberration curves, astigmatic field curves and a distortion curve of the image capturing unit according to the 4th embodiment. In FIG. 7, the image capturing unit 4 includes the photographing lens system (its reference numeral is omitted) of the present disclosure and an image sensor IS. The photographing lens system includes, in order from an object side to an image side along an optical path, an aperture stop ST, a first lens element E1, a stop S1, a second lens element E2, a third lens element E3, a fourth lens element E4, a stop S2, a fifth lens element E5, a filter E6 and an image surface IMG. The photographing lens system includes five lens elements (E1, E2, E3, E4 and E5) with no additional lens element disposed between each of the adjacent five lens elements.

The first lens element E1 with positive refractive power has an object-side surface being convex in a paraxial region thereof and an image-side surface being concave in a paraxial region thereof. The first lens element E1 is made of plastic material and has the object-side surface and the image-side surface being both aspheric. The object-side surface of the first lens element E1 has one inflection point. The image-side surface of the first lens element E1 has one inflection point. The image-side surface of the first lens element E1 has one critical point in an off-axis region thereof.

The second lens element E2 with positive refractive power has an object-side surface being convex in a paraxial region thereof and an image-side surface being convex in a paraxial region thereof. The second lens element E2 is made of plastic material and has the object-side surface and the image-side surface being both aspheric. The object-side surface of the second lens element E2 has one inflection point. The object-side surface of the second lens element E2 has one critical point in an off-axis region thereof.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric. The image-side surface of the third lens element E3 has one inflection point.

The fourth lens element E4 with negative refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has three inflection points. The image-side surface of the fourth lens element E4 has four inflection points. The object-side surface of the fourth lens element E4 has two critical points in an off-axis region thereof.

The fifth lens element E5 with positive refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has three inflection points. The object-side surface of the fifth lens element E5 has two critical points in an off-axis region thereof. The image-side surface of the fifth lens element E5 has one critical point in an off-axis region thereof.

The filter E6 is made of glass material and located between the fifth lens element E5 and the image surface IMG, and does not affect the focal length of the photographing lens system. The image sensor IS is disposed on or near the image surface IMG of the photographing lens system.

An average central thickness of the first lens element E1 to the fifth lens element E in the photographing lens system is 0.45 mm. Moreover, a central thickness of the first lens element E1 is 0.477 mm, and the central thickness (0.477 mm) of the first lens element E1 is larger than the average central thickness (0.45 mm) of all lens elements in the photographing lens system.

The detailed optical data of the 4th embodiment are shown in Table 4A and the aspheric surface data are shown in Table 4B below.

TABLE 4A
4th Embodiment
f = 2.80 mm, Fno = 2.23, HFOV = 46.6 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Ape. Stop | Plano | | −0.093 | | | | |
| 2 | Lens 1 | 1.4174 | (ASP) | 0.477 | Plastic | 1.545 | 56.1 | 3.57 |
| 3 | | 4.6126 | (ASP) | 0.081 | | | | |
| 4 | Stop | Plano | | 0.156 | | | | |
| 5 | Lens 2 | 200.0000 | (ASP) | 0.343 | Plastic | 1.544 | 56.0 | 6.93 |
| 6 | | −3.8431 | (ASP) | 0.184 | | | | |
| 7 | Lens 3 | −1.4278 | (ASP) | 0.292 | Plastic | 1.669 | 19.5 | 76.83 |
| 8 | | −1.5031 | (ASP) | 0.071 | | | | |
| 9 | Lens 4 | −1.0962 | (ASP) | 0.442 | Plastic | 1.587 | 28.3 | −3.60 |
| 10 | | −2.6134 | (ASP) | 0.036 | | | | |
| 11 | Stop | Plano | | 0.010 | | | | |
| 12 | Lens 5 | 0.7900 | (ASP) | 0.671 | Plastic | 1.544 | 56.0 | 4.38 |
| 13 | | 0.8282 | (ASP) | 0.607 | | | | |

| | | | | | | | |
|---|---|---|---|---|---|---|---|
| 14 | Filter | Plano | 0.210 | Glass | 1.517 | 64.2 | — |
| 15 | | Plano | 0.290 | | | | |
| 16 | Image | Plano | — | | | | |

Note:
Reference wavelength is 587.6 nm (d-line).
An effective radius of the stop S1 (Surface 4) is 0.650 mm.
An effective radius of the stop S2 (Surface 11) is 1.995 mm.

TABLE 4B
Aspheric Coefficients

| Surface # | 2 | 3 | 5 | 6 |
|---|---|---|---|---|
| k= | 2.64819E+00 | −2.14596E+01 | −9.90000E+01 | 1.39757E+01 |
| A4= | −1.420887377E−01 | −2.059185295E−01 | −2.464541853E−01 | −2.384143029E−01 |
| A6= | 1.979779696E−01 | 5.964871276E+00 | −2.686774692E−01 | −5.583274027E+00 |
| A8= | −1.612141147E+01 | −1.932635445E+02 | −6.231288921E+00 | 9.153785029E+01 |
| A10= | 4.449314788E+02 | 3.879512425E+03 | 1.794465354E+02 | −9.432483196E+02 |
| A12= | −7.982454944E+03 | −5.247739617E+04 | −2.932547041E+03 | 6.472214280E+03 |
| A14= | 9.484431581E+04 | 4.944112325E+05 | 2.994786050E+04 | −3.080622459E+04 |
| A16= | −7.737462836E+05 | −3.320520575E+06 | −2.071155248E+05 | 1.037301038E+05 |
| A18= | 4.432495067E+06 | 1.610046347E+07 | 1.004450977E+06 | −2.480950266E+05 |
| A20= | −1.798999734E+07 | −5.648981159E+07 | −3.454932115E+06 | 4.175473586E+05 |
| A22= | 5.146464503E+07 | 1.420497625E+08 | 8.378307320E+06 | −4.821954173E+05 |
| A24= | −1.014637520E+08 | −2.495438178E+08 | −1.398197394E+07 | 3.635011021E+05 |
| A26= | 1.311816541E+08 | 2.907760253E+08 | 1.525634825E+07 | −1.615406193E+05 |
| A28= | −1.000902946E+08 | −2.019002800E+08 | −9.785152119E+06 | 3.235060985E+04 |
| A30= | 3.415250540E+07 | 6.322039471E+07 | 2.794328218E+06 | — |
| Surface # | 7 | 8 | 9 | 10 |
| k= | −1.78367E−01 | −6.83720E+00 | −6.09737E+00 | −3.03349E−01 |
| A4= | −4.336819484E−01 | 2.795915275E+00 | 5.312447994E+00 | 3.510999457E−01 |
| A6= | −2.790419532E+00 | −2.620922895E+01 | −4.193402117E+01 | −3.214557699E+00 |
| A8= | −5.826437122E+01 | 1.080739364E+02 | 2.346795936E+02 | 2.489854731E+01 |
| A10= | 1.677942278E+03 | −7.008649279E+01 | −9.830231441E+02 | −9.757705962E+01 |
| A12= | −1.940721001E+04 | −1.877704027E+03 | 3.099310692E+03 | 2.313775118E+02 |
| A14= | 1.381622080E+05 | 1.225934177E+04 | −7.432072377E+03 | −3.673458836E+02 |
| A16= | −6.700711480E+05 | −4.255669624E+04 | 1.364244962E+04 | 4.105129445E+02 |
| A18= | 2.302678504E+06 | 9.684494752E+04 | −1.913508583E+04 | −3.304581361E+02 |
| A20= | −5.681417825E+06 | −1.526462612E+05 | 2.027669202E+04 | 1.927260454E+02 |
| A22= | 1.001594277E+07 | 1.684599173E+05 | −1.587992599E+04 | −8.070212212E+01 |
| A24= | −1.232364926E+07 | −1.280673866E+05 | 8.864580439E+03 | 2.363863726E+01 |
| A26= | 1.005702479E+07 | 6.397080472E+04 | −3.320122342E+03 | −4.594884952E+00 |
| A28= | −4.892554651E+06 | −1.890677721E+04 | 7.446368638E+02 | 5.320678388E−01 |
| A30= | 1.074041005E+06 | 2.505192236E+03 | −7.532812594E+01 | −2.775785723E−02 |

| Surface # | 12 | 13 |
|---|---|---|
| k= | −1.13609E+00 | −1.06268E+00 |
| A4= | −1.475112447E+00 | −8.000931322E−01 |
| A6= | 3.133724987E+00 | 1.097294807E+00 |
| A8= | −4.857172560E+00 | −1.266820126E+00 |
| A10= | 4.782673910E+00 | 1.104321787E+00 |
| A12= | −2.753773390E+00 | −7.195991809E−01 |
| A14= | 6.046533872E−01 | 3.529098541E−01 |
| A16= | 3.662017406E−01 | −1.308660634E−01 |
| A18= | −3.949704835E−01 | 3.663850686E−02 |
| A20= | 1.822611567E−01 | −7.675448765E−03 |
| A22= | −5.184419273E−02 | 1.181242767E−03 |
| A24= | 9.624213355E−03 | −1.293143026E−04 |
| A26= | −1.142347669E−03 | 9.515535533E−06 |
| A28= | 7.906263343E−05 | −4.215354753E−07 |
| A30= | −2.434440154E−06 | 8.494456608E−09 |

In the 4th embodiment, the equation of the aspheric surface profiles of the aforementioned lens elements is the same as the equation of the 1st embodiment. Also, the definitions of these parameters shown in Table 40 below are the same as those stated in the 1st embodiment, with corresponding values for the 4th embodiment; therefore, an explanation in this regard will not be provided again.

Moreover, these parameters can be calculated from Table 4A and Table 4B3 as the following values and satisfy the following conditions:

TABLE 4C
Values of Optical and Physical Parameters/Definitions

| | | | |
|---|---|---|---|
| f [mm] | 2.80 | f/R5 | −1.96 |
| Fno | 2.23 | f/R6 | −1.86 |
| HFOV [deg.] | 46.6 | f/f5 | 0.64 |
| FOV [deg.] | 93.2 | f1/f2 | 0.51 |
| V3 + V4 | 47.8 | f5/f4 | −1.22 |
| V4 − V3 | 8.8 | \|f1/f3\| | 0.05 |
| V4/V5 | 0.51 | \|f2/f3\| | 0.09 |
| V5 − V4 | 27.7 | \|f4/f3\| | 0.05 |
| V1 + V2 | 112.1 | \|f5/f3\| | 0.06 |
| V2 − V3 | 36.5 | \|f4/f\| + \|f5/f\| | 2.85 |
| CT1/[(CT2 + CT3 + CT4)/3] | 1.33 | f/f2345 | 0.20 |
| ΣCT/ΣAT | 4.14 | f23/f | 2.45 |
| R5/Dr5I | −0.54 | TL/ImgH | 1.29 |
| R6/Dr6I | −0.64 | TL/f | 1.38 |

### 5th Embodiment

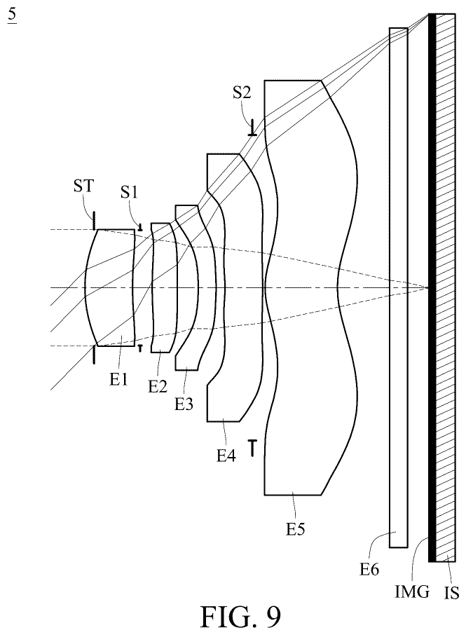

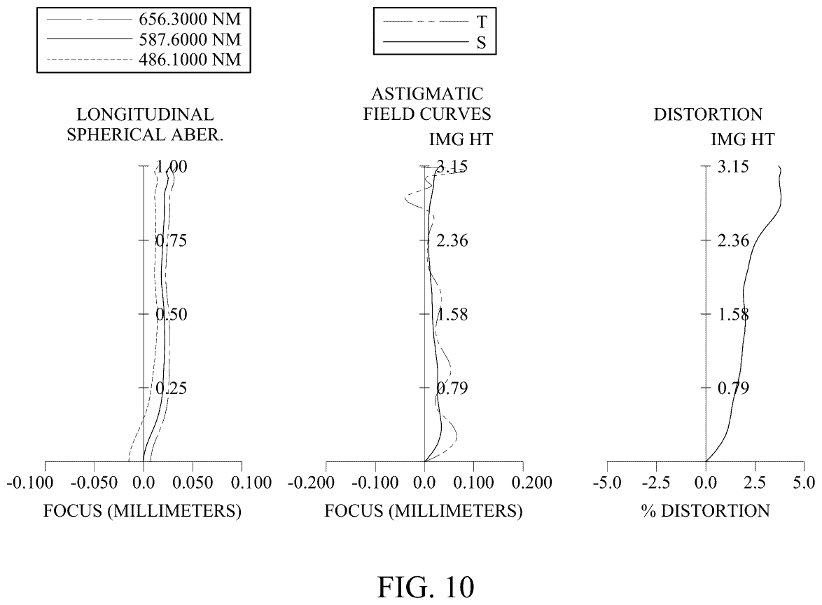

FIG. 9 is a schematic view of an image capturing unit according to the 5th embodiment of the present disclosure. FIG. 10 shows, in order from left to right, spherical aberration curves, astigmatic field curves and a distortion curve of the image capturing unit according to the 5th embodiment. In FIG. 9, the image capturing unit 5 includes the photographing lens system (its reference numeral is omitted) of the present disclosure and an image sensor IS. The photographing lens system includes, in order from an object side to an image side along an optical path, an aperture stop ST, a first lens element E1, a stop S1, a second lens element E2, a third lens element E3, a fourth lens element E4, a stop S2, a fifth lens element E5, a filter E6 and an image surface IMG. The photographing lens system includes five lens elements (E1, E2, E3, E4 and E5) with no additional lens element disposed between each of the adjacent five lens elements.

The first lens element E1 with positive refractive power has an object-side surface being convex in a paraxial region thereof and an image-side surface being concave in a paraxial region thereof. The first lens element E1 is made of plastic material and has the object-side surface and the image-side surface being both aspheric. The object-side surface of the first lens element E1 has one inflection point.

The image-side surface of the first lens element E1 has one inflection point. The image-side surface of the first lens element E1 has one critical point in an off-axis region thereof.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has one inflection point. The object-side surface of the second lens element E2 has one critical point in an off-axis region thereof. The image-side surface of the second lens element E2 has one critical point in an off-axis region thereof.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric. The object-side surface of the third lens element E3 has two inflection points. The image-side surface of the third lens element E3 has one inflection point.

The fourth lens element E4 with negative refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has three inflection points. The image-side surface of the fourth lens element E4 has three inflection points. The object-side surface of the fourth lens element E4 has two critical points in an off-axis region thereof. The image-side surface of the fourth lens element E4 has two critical points in an off-axis region thereof.

The fifth lens element E5 with positive refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has three inflection points. The image-side surface of the fifth lens element E5 has three inflection points. The object-side surface of the fifth lens element E5 has one critical point in an off-axis region thereof. The image-side surface of the fifth lens element E5 has one critical point in an off-axis region thereof.

The filter E6 is made of glass material and located between the fifth lens element E5 and the image surface IMG, and does not affect the focal length of the photographing lens system. The image sensor IS is disposed on or near the image surface IMG of the photographing lens system.

An average central thickness of the first lens element E1 to the fifth lens element E in the photographing lens system is 0.46 mm. Moreover, a central thickness of the first lens element E1 is 0.550 mm, and the central thickness (0.550 mm) of the first lens element E1 is larger than the average central thickness (0.46 mm) of all lens elements in the photographing lens system.

The detailed optical data of the 5th embodiment are shown in Table 5A and the aspheric surface data are shown in Table 5B below.

TABLE 5A
5th Embodiment
f = 2.98 mm, Fno = 2.22, HFOV = 45.4 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Ape. Stop | Plano | | −0.105 | | | | |
| 2 | Lens 1 | 1.4738 | (ASP) | 0.550 | Plastic | 1.545 | 56.1 | 4.04 |
| 3 | | 3.8631 | (ASP) | 0.088 | | | | |
| 4 | Stop | Plano | | 0.139 | | | | |
| 5 | Lens 2 | 4.5809 | (ASP) | 0.289 | Plastic | 1.544 | 56.0 | 8.86 |
| 6 | | 90.5152 | (ASP) | 0.242 | | | | |
| 7 | Lens 3 | −2.2778 | (ASP) | 0.206 | Plastic | 1.669 | 19.5 | 19.32 |
| 8 | | −2.0068 | (ASP) | 0.103 | | | | |
| 9 | Lens 4 | −1.2447 | (ASP) | 0.434 | Plastic | 1.614 | 25.6 | −2.78 |
| 10 | | −5.2383 | (ASP) | −0.118 | | | | |
| 11 | Stop | Plano | | 0.147 | | | | |
| 12 | Lens 5 | 0.8751 | (ASP) | 0.834 | Plastic | 1.544 | 56.0 | 3.43 |
| 13 | | 1.0959 | (ASP) | 0.600 | | | | |

| | | | | | | | |
|---|---|---|---|---|---|---|---|
| 14 | Filter | Plano | 0.210 | Glass | 1.517 | 64.2 | — |
| 15 | | Plano | 0.246 | | | | |
| 16 | Image | Plano | — | | | | |

Note:
Reference wavelength is 587.6 nm (d-line).
An effective radius of the stop S1 (Surface 4) is 0.666 mm.
An effective radius of the stop S2 (Surface 11) is 1.763 mm.

TABLE 5B
Aspheric Coefficients

| Surface # | 2 | 3 | 5 | 6 |
|---|---|---|---|---|
| k= | 2.41460E+00 | 3.42543E+00 | 3.02325E+01 | −9.90000E+01 |
| A4= | −1.453374533E−01 | −5.314986895E−02 | −3.210983619E−01 | −3.944181932E−01 |
| A6= | 1.684932420E+00 | −3.353529466E+00 | 5.626638704E+00 | 5.242178490E+00 |
| A8= | −6.282392977E+01 | 9.668478429E+01 | −1.293786539E+02 | −8.080970638E+01 |
| A10= | 1.307590647E+03 | −1.814993679E+03 | 1.860242796E+03 | 8.051405705E+02 |
| A12= | −1.783455656E+04 | 2.276888785E+04 | −1.847033435E+04 | −5.528672825E+03 |
| A14= | 1.662947065E+05 | −1.998317630E+05 | 1.298890557E+05 | 2.666394585E+04 |
| A16= | −1.089939810E+06 | 1.257630491E+06 | −6.587298755E+05 | −9.169952028E+04 |
| A18= | 5.097202181E+06 | −5.741334021E+06 | 2.430192481E+06 | 2.260405384E+05 |
| A20= | −1.706978910E+07 | 1.902214505E+07 | −6.517180820E+06 | −3.966596614E+05 |
| A22= | 4.058041421E+07 | −4.523053290E+07 | 1.255564636E+07 | 4.842598614E+05 |
| A24= | −6.680218748E+07 | 7.514440330E+07 | −1.690977384E+07 | −3.912806577E+05 |
| A26= | 7.233853268E+07 | −8.274993300E+07 | 1.509601505E+07 | 1.881949765E+05 |
| A28= | −4.631619425E+07 | 5.423677586E+07 | −8.017596536E+06 | −4.079611019E+04 |
| A30= | 1.327535096E+07 | −1.600834257E+07 | 1.915657400E+06 | — |

| Surface # | 7 | 8 | 9 | 10 |
|---|---|---|---|---|
| k= | −5.68886E−01 | −5.03456E+00 | −1.00000E+00 | 1.29500E+00 |
| A4= | 9.882724198E−02 | 2.725710206E+00 | 4.733268925E+00 | 8.199389568E−01 |
| A6= | −1.046754635E+01 | −2.917393656E+01 | −3.112498184E+01 | −6.103619204E+00 |
| A8= | 7.377874604E+01 | 1.821373615E+02 | 1.499793768E+02 | 3.018720140E+01 |
| A10= | −1.572819067E+02 | −8.717317400E+02 | −5.464045534E+02 | −9.221234138E+01 |
| A12= | −2.066263491E+03 | 3.238135532E+03 | 1.489231733E+03 | 1.855587138E+02 |
| A14= | 2.539770641E+04 | −9.176553168E+03 | −3.029387752E+03 | −2.599287779E+02 |
| A16= | −1.510447611E+05 | 1.953286496E+04 | 4.590362422E+03 | 2.617490519E+02 |
| A18= | 5.787217326E+05 | −3.069581827E+04 | −5.144996392E+03 | −1.924049585E+02 |
| A20= | −1.521262384E+06 | 3.483391680E+04 | 4.197736767E+03 | 1.034523607E+02 |
| A22= | 2.776368472E+06 | −2.762080961E+04 | −2.418916714E+03 | −4.025152347E+01 |
| A24= | −3.462851344E+06 | 1.447118533E+04 | 9.313680037E+02 | 1.103239202E+01 |
| A26= | 2.817570682E+06 | −4.490787344E+03 | −2.146117619E+02 | −2.020126336E+00 |
| A28= | −1.348155814E+06 | 6.239021548E+02 | 2.233460540E+01 | 2.218033006E−01 |
| A30= | 2.877681847E+05 | — | — | −1.104260985E−02 |

| Surface # | 12 | 13 |
|---|---|---|
| k= | −1.07969E+00 | −1.00000E+00 |
| A4= | −1.052574722E+00 | −4.781818310E−01 |
| A6= | 8.676943618E−01 | 4.496159601E−01 |
| A8= | 1.565143962E+00 | −4.337612814E−01 |
| A10= | −6.323315255E+00 | 4.150554349E−01 |
| A12= | 1.013710508E+01 | −3.455580523E−01 |
| A14= | −9.956469682E+00 | 2.172314609E−01 |
| A16= | 6.619199319E+00 | −9.714751455E−02 |
| A18= | −3.094067787E+00 | 3.037675637E−02 |
| A20= | 1.030111899E+00 | −6.567789845E−03 |
| A22= | −2.432120513E−01 | 9.603605478E−04 |
| A24= | 3.980973245E−02 | −9.055377659E−05 |
| A26= | −4.296552600E−03 | 4.966208265E−06 |
| A28= | 2.749846545E−04 | −1.202978680E−07 |
| A30= | −7.903570735E−06 | — |

In the 5th embodiment, the equation of the aspheric surface profiles of the aforementioned lens elements is the same as the equation of the 1st embodiment. Also, the definitions of these parameters shown in Table 5C below are the same as those stated in the 1st embodiment, with corresponding values for the 5th embodiment; therefore, an explanation in this regard will not be provided again.

Moreover, these parameters can be calculated from Table 5A and Table 51B as the following values and satisfy the following conditions:

TABLE 5C
Values of Optical and Physical Parameters/Definitions

| | | | |
|---|---|---|---|
| f [mm] | 2.98 | f/R5 | −1.31 |
| Fno | 2.22 | f/R6 | −1.49 |
| HFOV [deg.] | 45.4 | f/f5 | 0.87 |
| FOV [deg.] | 90.8 | f1/f2 | 0.46 |
| V3 + V4 | 45.1 | f5/f4 | −1.23 |
| V4 − V3 | 6.1 | \|f1/f3\| | 0.21 |
| V4/V5 | 0.46 | \|f2/f3\| | 0.46 |
| V5 − V4 | 30.4 | \|f4/f3\| | 0.14 |
| V1 + V2 | 112.1 | \|f5/f3\| | 0.18 |
| V2 − V3 | 36.5 | \|f4/f\| + \|f5/f\| | 2.08 |
| CT1/[(CT2 + CT3 + CT4)/3] | 1.78 | f/f2345 | 0.19 |
| ΣCT/ΣAT | 3.85 | f23/f | 2.13 |
| R5/Dr5I | −0.86 | TL/ImgH | 1.26 |
| R6/Dr6I | −0.82 | TL/f | 1.33 |

### 6th Embodiment

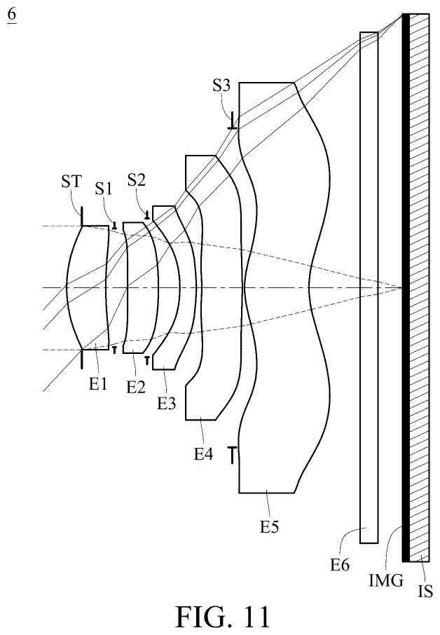

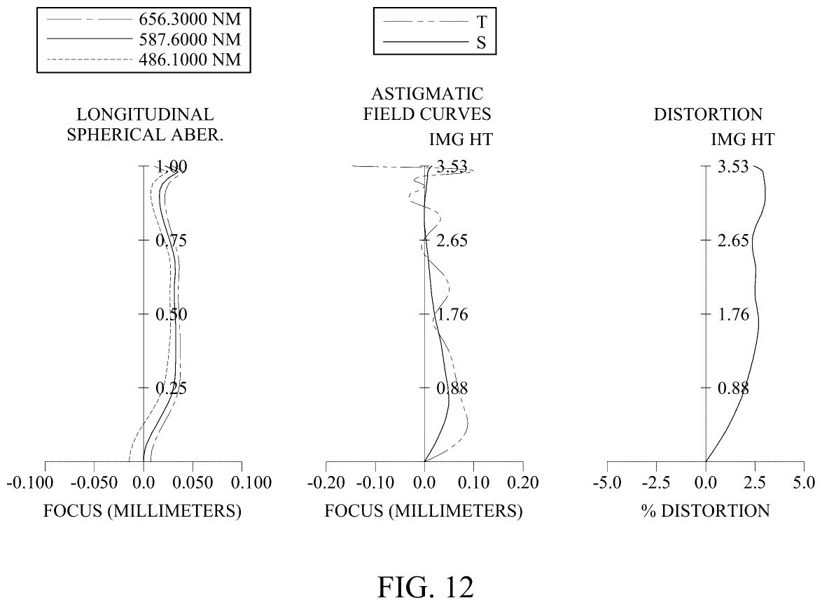

FIG. 11 is a schematic view of an image capturing unit according to the 6th embodiment of the present disclosure. FIG. 12 shows, in order from left to right, spherical aberration curves, astigmatic field curves and a distortion curve of the image capturing unit according to the 6th embodiment. In FIG. 11, the image capturing unit 6 includes the photographing lens system (its reference numeral is omitted) of the present disclosure and an image sensor IS. The photographing lens system includes, in order from an object side to an image side along an optical path, an aperture stop ST, a first lens element E1, a stop S1, a second lens element E2, a stop S2, a third lens element E3, a fourth lens element E4, a stop S3, a fifth lens element E5, a filter E6 and an image surface IMG. The photographing lens system includes five lens elements (E1, E2, E3, E4 and E5) with no additional lens element disposed between each of the adjacent five lens elements.

The first lens element E1 with positive refractive power has an object-side surface being convex in a paraxial region thereof and an image-side surface being concave in a paraxial region thereof. The first lens element E1 is made of plastic material and has the object-side surface and the image-side surface being both aspheric. The object-side surface of the first lens element E1 has two inflection points. The image-side surface of the first lens element E1 has one inflection point. The image-side surface of the first lens element E1 has one critical point in an off-axis region thereof.

The second lens element E2 with positive refractive power has an object-side surface being convex in a paraxial region thereof and an image-side surface being convex in a paraxial region thereof. The second lens element E2 is made of plastic material and has the object-side surface and the image-side surface being both aspheric. The object-side surface of the second lens element E2 has one inflection point. The object-side surface of the second lens element E2 has one critical point in an off-axis region thereof.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric. The image-side surface of the third lens element E3 has one inflection point.

The fourth lens element E4 with negative refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has three inflection points. The image-side surface of the fourth lens element E4 has three inflection points. The object-side surface of the fourth lens element E4 has two critical points in an off-axis region thereof. The image-side surface of the fourth lens element E4 has two critical points in an off-axis region thereof.

The fifth lens element E5 with positive refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has three inflection points. The image-side surface of the fifth lens element E5 has three inflection points. The object-side surface of the fifth lens element E5 has two critical points in an off-axis region thereof. The image-side surface of the fifth lens element E5 has one critical point in an off-axis region thereof.

The filter E6 is made of glass material and located between the fifth lens element E5 and the image surface IMG, and does not affect the focal length of the photographing lens system. The image sensor IS is disposed on or near the image surface IMG of the photographing lens system.

An average central thickness of the first lens element E1 to the fifth lens element E5 in the photographing lens system is 0.49 mm. Moreover, a central thickness of the first lens element E1 is 0.505 mm, and the central thickness (0.505 mm) of the first lens element E1 is larger than the average central thickness (0.49 mm) of all lens elements in the photographing lens system.

The detailed optical data of the 6th embodiment are shown in Table 6A and the aspheric surface data are shown in Table 6B below.

TABLE 6A
6th Embodiment
f = 3.17 mm, Fno = 1.98, HFOV = 47.2 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Ape. Stop | Plano | | −0.196 | | | | |
| 2 | Lens 1 | 1.5702 | (ASP) | 0.505 | Plastic | 1.545 | 56.1 | 4.35 |
| 3 | | 4.1157 | (ASP) | 0.113 | | | | |
| 4 | Stop | Plano | | 0.169 | | | | |
| 5 | Lens 2 | 38.2766 | (ASP) | 0.398 | Plastic | 1.544 | 56.0 | 6.88 |
| 6 | | −4.1323 | (ASP) | −0.146 | | | | |
| 7 | Stop | Plano | | 0.423 | | | | |
| 8 | Lens 3 | −1.5299 | (ASP) | 0.213 | Plastic | 1.669 | 19.5 | 346.77 |
| 9 | | −1.6047 | (ASP) | 0.071 | | | | |
| 10 | Lens 4 | −1.6035 | (ASP) | 0.523 | Plastic | 1.614 | 25.6 | −4.07 |
| 11 | | −5.0319 | (ASP) | −0.130 | | | | |
| 12 | Stop | Plano | | 0.160 | | | | |
| 13 | Lens 5 | 1.0337 | (ASP) | 0.832 | Plastic | 1.544 | 56.0 | 5.02 |
| 14 | | 1.1918 | (ASP) | 0.660 | | | | |

| | | | | | | | |
|---|---|---|---|---|---|---|---|
| 15 | Filter | Plano | 0.231 | Glass | 1.517 | 64.2 | — |
| 16 | | Plano | 0.320 | | | | |
| 17 | Image | Plano | — | | | | |

Note:
Reference wavelength is 587.6 nm (d-line).
An effective radius of the stop S1 (Surface 4) is 0.766 mm.
An effective radius of the stop S2 (Surface 7) is 0.896 mm.
An effective radius of the stop S3 (Surface 12) is 2.061 mm.

TABLE 6B
Aspheric Coefficients

| Surface # | 2 | 3 | 5 | 6 |
|---|---|---|---|---|
| k= | 1.58009E+00 | 1.46354E+01 | 9.90000E+01 | −3.36024E+01 |
| A4= | −6.439915964E−02 | −1.039845234E−01 | −2.698867999E−01 | −2.048524636E−01 |
| A6= | −1.494831054E−01 | 1.446317798E+00 | 5.055437968E+00 | −5.919159651E−01 |
| A8= | 5.554076881E+00 | −3.244458281E+01 | −9.141846087E+01 | 8.276602103E+00 |
| A10= | −9.422991009E+01 | 4.502064546E+02 | 1.043516257E+03 | −6.642050344E+01 |
| A12= | 8.761345506E+02 | −4.275344621E+03 | −8.128350350E+03 | 3.367216846E+02 |
| A14= | −5.201638609E+03 | 2.855729452E+04 | 4.463442457E+04 | −1.140717223E+03 |
| A16= | 2.085554075E+04 | −1.367595612E+05 | −1.764621530E+05 | 2.612979428E+03 |
| A18= | −5.763453203E+04 | 4.740519562E+05 | 5.075986586E+05 | −4.013539094E+03 |
| A20= | 1.093020081E+05 | −1.189602570E+06 | −1.062875175E+06 | 4.011744924E+03 |
| A22= | −1.376946665E+05 | 2.138102718E+06 | 1.602349827E+06 | −2.445296681E+03 |
| A24= | 1.057495733E+05 | −2.681691386E+06 | −1.693408752E+06 | 7.909690667E+02 |
| A26= | −3.783249823E+04 | 2.228509697E+06 | 1.190149140E+06 | −9.398466283E+01 |
| A28= | −3.407776276E+03 | −1.102610707E+06 | −4.994198830E+05 | — |
| A30= | 5.143340448E+03 | 2.459103729E+05 | 9.465118877E+04 | — |

| Surface # | 8 | 9 | 10 | 11 |
|---|---|---|---|---|
| k= | −3.41455E+00 | 0.00000E+00 | −1.00000E+00 | −5.74171E+00 |
| A4= | −6.604661729E−02 | 2.276294419E+00 | 3.546875616E+00 | 5.418302294E−01 |
| A6= | −7.579825452E+00 | −1.642242035E+01 | −1.987909406E+01 | −2.924842173E+00 |
| A8= | 1.014946564E+02 | 6.287961909E+01 | 7.474603054E+01 | 1.058824062E+01 |
| A10= | −1.003440785E+03 | −1.555569654E+02 | −2.016100776E+02 | −2.473526636E+01 |
| A12= | 7.050566932E+03 | 2.622847754E+02 | 3.999962151E+02 | 3.933675930E+01 |
| A14= | −3.450323631E+04 | −3.036699389E+02 | −5.917442150E+02 | −4.455046247E+01 |
| A16= | 1.190459777E+05 | 2.378931409E+02 | 6.547432191E+02 | 3.682361567E+01 |
| A18= | −2.933532588E+05 | −1.207995091E+02 | −5.386401848E+02 | −2.244020879E+01 |
| A20= | 5.183795011E+05 | 3.599065145E+01 | 3.243110457E+02 | 1.007112093E+01 |
| A22= | −6.515303269E+05 | −4.788744042E+00 | −1.386850082E+02 | −3.287087678E+00 |
| A24= | 5.682168199E+05 | — | 3.985838655E+01 | 7.587192966E−01 |
| A26= | −3.266156033E+05 | — | −6.896115189E+00 | −1.173614282E−01 |
| A28= | 1.111793151E+05 | — | 5.419465223E−01 | 1.091180378E−02 |
| A30= | −1.696029016E+04 | — | — | −4.607990295E−04 |

| Surface # | 13 | 14 |
|---|---|---|
| k= | −1.06155E+00 | −1.00000E+00 |
| A4= | −5.799392460E−01 | −3.325119483E−01 |
| A6= | 6.841874147E−02 | 2.374952072E−01 |
| A8= | 1.285960189E+00 | −1.870330584E−01 |
| A10= | −2.861104415E+00 | 1.548270958E−01 |
| A12= | 3.433041215E+00 | −1.117685792E−01 |
| A14= | −2.700636250E+00 | 5.990889418E−02 |
| A16= | 1.479306055E+00 | −2.257044411E−02 |
| A18= | −5.778325753E−01 | 5.904288889E−03 |
| A20= | 1.620042147E−01 | −1.063482562E−03 |
| A22= | −3.236216430E−02 | 1.291840035E−04 |
| A24= | 4.496642556E−03 | −1.009826377E−05 |
| A26= | −4.130899141E−04 | 4.583611527E−07 |
| A28= | 2.256073813E−05 | −9.176042901E−09 |
| A30= | −5.547393565E−07 | — |

In the 6th embodiment, the equation of the aspheric surface profiles of the aforementioned lens elements is the same as the equation of the 1st embodiment. Also, the definitions of these parameters shown in Table 60 below are the same as those stated in the 1st embodiment, with corresponding values for the 6th embodiment; therefore, an explanation in this regard will not be provided again.

Moreover, these parameters can be calculated from Table 6A and Table 6B3 as the following values and satisfy the following conditions:

TABLE 6C
Values of Optical and Physical Parameters/Definitions

| | | | |
|---|---|---|---|
| f [mm] | 3.17 | f/R5 | −2.08 |
| Fno | 1.98 | f/R6 | −1.98 |
| HFOV [deg.] | 47.2 | f/f5 | 0.63 |
| FOV [deg.] | 94.4 | f1/f2 | 0.63 |
| V3 + V4 | 45.1 | f5/f4 | −1.23 |
| V4 − V3 | 6.1 | \|f1/f3\| | 0.01 |
| V4/V5 | 0.46 | \|f2/f3\| | 0.02 |
| V5 − V4 | 30.4 | \|f4/f3\| | 0.01 |
| V1 + V2 | 112.1 | \|f5/f3\| | 0.01 |
| V2 − V3 | 36.5 | \|f4/f\| + \|f5/f\| | 2.86 |
| CT1/[(CT2 + CT3 + CT4)/3] | 1.34 | f/f2345 | 0.25 |
| ΣCT/ΣAT | 3.74 | f23/f | 2.24 |
| R5/Dr5I | −0.53 | TL/ImgH | 1.23 |
| R6/Dr6I | −0.60 | TL/f | 1.37 |

### 7th Embodiment

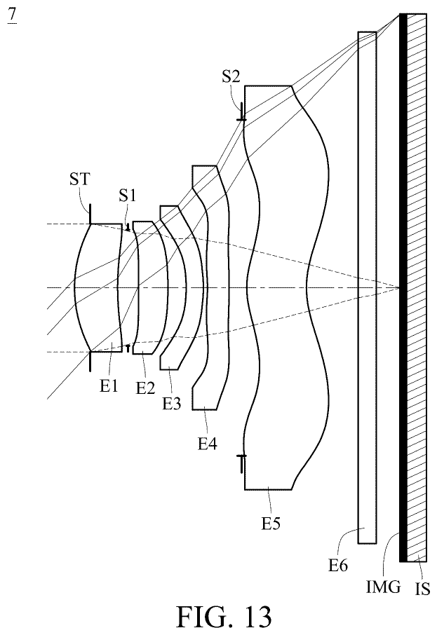

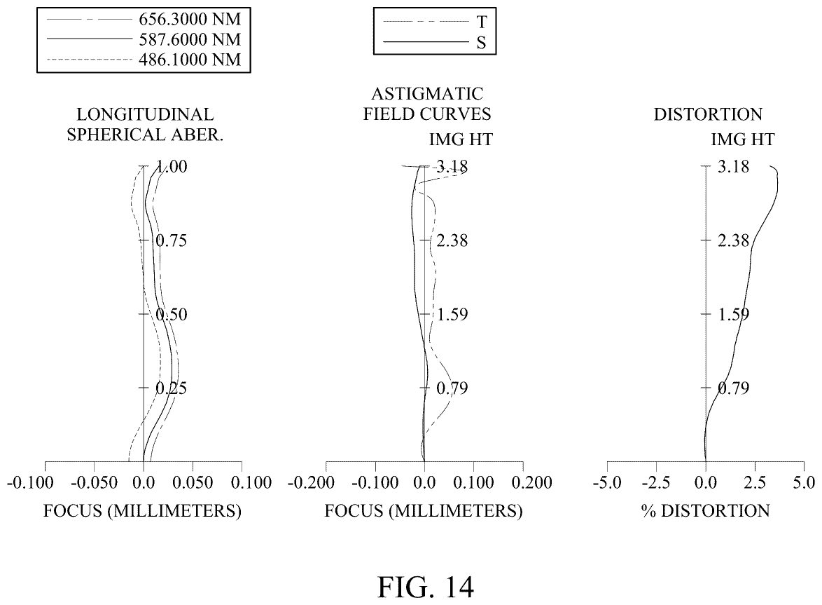

FIG. 13 is a schematic view of an image capturing unit according to the 7th embodiment of the present disclosure. FIG. 14 shows, in order from left to right, spherical aberration curves, astigmatic field curves and a distortion curve of the image capturing unit according to the 7th embodiment. In FIG. 13, the image capturing unit 7 includes the photographing lens system (its reference numeral is omitted) of the present disclosure and an image sensor IS. The photographing lens system includes, in order from an object side to an image side along an optical path, an aperture stop ST, a first lens element E1, a stop S1, a second lens element E2, a third lens element E3, a fourth lens element E4, a stop S2, a fifth lens element E5, a filter E6 and an image surface IMG. The photographing lens system includes five lens elements (E1, E2, E3, E4 and E5) with no additional lens element disposed between each of the adjacent five lens elements.

The first lens element E1 with positive refractive power has an object-side surface being convex in a paraxial region thereof and an image-side surface being concave in a paraxial region thereof. The first lens element E1 is made of glass material and has the object-side surface and the image-side surface being both aspheric. The image-side surface of the first lens element E1 has one inflection point. The image-side surface of the first lens element E1 has one critical point in an off-axis region thereof.

The second lens element E2 with positive refractive power has an object-side surface being convex in a paraxial region thereof and an image-side surface being convex in a paraxial region thereof. The second lens element E2 is made of plastic material and has the object-side surface and the image-side surface being both aspheric. The object-side surface of the second lens element E2 has one inflection point. The object-side surface of the second lens element E2 has one critical point in an off-axis region thereof.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric. The image-side surface of the third lens element E3 has one inflection point.

The fourth lens element E4 with negative refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has three inflection points. The image-side surface of the fourth lens element E4 has four inflection points. The object-side surface of the fourth lens element E4 has two critical points in an off-axis region thereof. The image-side surface of the fourth lens element E4 has two critical points in an off-axis region thereof.

The fifth lens element E5 with positive refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has three inflection points. The image-side surface of the fifth lens element E5 has three inflection points. The object-side surface of the fifth lens element E5 has two critical points in an off-axis region thereof. The image-side surface of the fifth lens element E5 has one critical point in an off-axis region thereof.

The filter E6 is made of glass material and located between the fifth lens element E5 and the image surface IMG, and does not affect the focal length of the photographing lens system. The image sensor IS is disposed on or near the image surface IMG of the photographing lens system.

An average central thickness of the first lens element E1 to the fifth lens element E5 in the photographing lens system is 0.40 mm. Moreover, a central thickness of the first lens element E1 is 0.500 mm, and the central thickness (0.500 mm) of the first lens element E1 is larger than the average central thickness (0.40 mm) of all lens elements in the photographing lens system.

The detailed optical data of the 7th embodiment are shown in Table 7A and the aspheric surface data are shown in Table 7B below.

TABLE 7A
7th Embodiment
f = 2.80 mm, Fno = 1.88, HFOV = 47.6 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Ape. Stop | Plano | | −0.182 | | | | |
| 2 | Lens 1 | 1.4696 | (ASP) | 0.500 | Glass | 1.589 | 61.2 | 4.21 |
| 3 | | 3.1519 | (ASP) | 0.119 | | | | |
| 4 | Stop | Plano | | 0.123 | | | | |
| 5 | Lens 2 | 42.2599 | (ASP) | 0.341 | Plastic | 1.544 | 56.0 | 6.88 |
| 6 | | −4.0957 | (ASP) | 0.212 | | | | |
| 7 | Lens 3 | −1.6692 | (ASP) | 0.200 | Plastic | 1.669 | 19.5 | 7.01 |
| 8 | | −1.2904 | (ASP) | 0.047 | | | | |
| 9 | Lens 4 | −1.3755 | (ASP) | 0.251 | Plastic | 1.639 | 23.5 | −2.92 |
| 10 | | −5.6256 | (ASP) | 0.145 | | | | |
| 11 | Stop | Plano | | 0.060 | | | | |
| 12 | Lens 5 | 0.9324 | (ASP) | 0.692 | Plastic | 1.534 | 56.0 | 4.96 |
| 13 | | 1.0662 | (ASP) | 0.600 | | | | |

| | | | | | | | |
|---|---|---|---|---|---|---|---|
| 14 | Filter | Plano | 0.210 | Glass | 1.517 | 64.2 | — |
| 15 | | Plano | 0.276 | | | | |
| 16 | Image | Plano | — | | | | |

Note:
Reference wavelength is 587.6 nm (d-line).
An effective radius of the stop S1 (Surface 4) is 0.673 mm.
An effective radius of the stop S2 (Surface 11) is 1.950 mm.

TABLE 7B
Aspheric Coefficients

| Surface # | 2 | 3 | 5 | 6 |
|---|---|---|---|---|
| k= | 1.15664E+00 | 1.12763E+01 | 9.90000E+01 | −2.51876E+01 |
| A4= | −1.351413069E−01 | −9.615849656E−02 | −2.258815082E−01 | −3.301366579E−01 |
| A6= | 2.111053921E+00 | 1.958263217E+00 | 1.174198300E+00 | 9.166981641E−01 |
| A8= | −3.336585102E+01 | −8.004467109E+01 | −1.828178791E+00 | −2.095225762E+01 |
| A10= | 3.163273511E+02 | 1.714141149E+03 | −3.308468657E+02 | 2.547711464E+02 |
| A12= | −1.818454966E+03 | −2.341185250E+04 | 6.210125142E+03 | −1.910805700E+03 |
| A14= | 5.444578696E+03 | 2.163110923E+05 | −6.097082918E+04 | 9.315933798E+03 |
| A16= | 1.025999568E+03 | −1.399006327E+06 | 3.844270775E+05 | −3.048968599E+04 |
| A18= | −8.298612667E+04 | 6.447880658E+06 | −1.661651811E+06 | 6.770682245E+04 |
| A20= | 3.775311546E+05 | −2.128340166E+07 | 5.040385316E+06 | −1.008065930E+05 |
| A22= | −9.384955604E+05 | 4.991618763E+07 | −1.073388094E+07 | 9.644615717E+04 |
| A24= | 1.457347723E+06 | −8.117259813E+07 | 1.572482802E+07 | −5.362241311E+04 |
| A26= | −1.412270854E+06 | 8.697720828E+07 | −1.509040670E+07 | 1.317134700E+04 |
| A28= | 7.850699359E+05 | −5.521104921E+07 | 8.537466379E+06 | — |
| A30= | −1.918160377E+05 | 1.572338374E+07 | −2.157364807E+06 | — |

| Surface # | 7 | 8 | 9 | 10 |
|---|---|---|---|---|
| k= | −3.02412E+00 | 0.00000E+00 | −1.00000E+00 | −4.44300E+00 |
| A4= | −3.260130306E−01 | 2.901249521E+00 | 4.402769022E+00 | 3.394100262E−01 |
| A6= | −1.122583392E+01 | −2.833456009E+01 | −2.986916764E+01 | −1.709586579E+00 |
| A8= | 1.763240910E+02 | 1.760786802E+02 | 1.459802672E+02 | 1.120115609E+01 |
| A10= | −1.673689124E+03 | −8.452689411E+02 | −5.235498346E+02 | −4.595270420E+01 |
| A12= | 1.044086506E+04 | 3.176759295E+03 | 1.381733982E+03 | 1.214224003E+02 |
| A14= | −4.265001882E+04 | −9.077610860E+03 | −2.691269669E+03 | −2.222341554E+02 |
| A16= | 1.094832069E+05 | 1.921399499E+04 | 3.857836406E+03 | 2.913810985E+02 |
| A18= | −1.453962620E+05 | −2.946714830E+04 | −4.034041806E+03 | −2.770953680E+02 |
| A20= | −4.270648320E+04 | 3.188724756E+04 | 3.024998642E+03 | 1.910212621E+02 |
| A22= | 5.685576598E+05 | −2.330682058E+04 | −1.578111970E+03 | −9.429941490E+01 |
| A24= | −1.108307014E+06 | 1.052899490E+04 | 5.423464539E+02 | 3.243528971E+01 |
| A26= | 1.115649868E+06 | −2.288669023E+03 | −1.101634480E+02 | −7.372904668E+00 |
| A28= | −6.006898189E+05 | −6.357716972E+01 | 1.000453754E+01 | 9.946061187E−01 |
| A30= | 1.372805507E+05 | 9.162093153E+01 | — | −6.025675596E−02 |

| Surface # | 12 | 13 |
|---|---|---|
| k= | −1.05167E+00 | −1.00000E+00 |
| A4= | −9.201092141E−01 | −4.371154997E−01 |
| A6= | 1.337558520E+00 | 3.949017588E−01 |
| A8= | −1.842739517E+00 | −4.279068795E−01 |
| A10= | 2.078017195E+00 | 4.536646830E−01 |
| A12= | −1.747150054E+00 | −3.817579144E−01 |
| A14= | 1.041297526E+00 | 2.330413495E−01 |
| A16= | −4.310348485E−01 | −1.010293102E−01 |
| A18= | 1.225339011E−01 | 3.091145111E−02 |
| A20= | −2.344879581E−02 | −6.602944932E−03 |
| A22= | 2.887695231E−03 | 9.606325009E−04 |
| A24= | −2.068683705E−04 | −9.049677100E−05 |
| A26= | 6.557173623E−06 | 4.966208455E−06 |
| A28= | — | −1.202978733E−07 |

In the 7th embodiment, the equation of the aspheric surface profiles of the aforementioned lens elements is the same as the equation of the 1st embodiment. Also, the definitions of these parameters shown in Table 70 below are the same as those stated in the 1st embodiment, with corresponding values for the 7th embodiment; therefore, an explanation in this regard will not be provided again.

Moreover, these parameters can be calculated from Table 7A and Table 71B as the following values and satisfy the following conditions:

TABLE 7C
Values of Optical and Physical Parameters/Definitions

| | | | |
|---|---|---|---|
| f [mm] | 2.80 | f/R5 | −1.68 |
| Fno | 1.88 | f/R6 | −2.17 |
| HFOV [deg.] | 47.6 | f/f5 | 0.56 |
| FOV [deg.] | 95.2 | f1/f2 | 0.61 |
| V3 + V4 | 43.0 | f5/f4 | −1.70 |
| V4 − V3 | 4.0 | \|f1/f3\| | 0.60 |
| V4/V5 | 0.42 | \|f2/f3\| | 0.98 |
| V5 − V4 | 32.5 | \|f4/f3\| | 0.42 |
| V1 + V2 | 117.3 | \|f5/f3\| | 0.71 |
| V2 − V3 | 36.5 | \|f4/f\| + \|f5/f\| | 2.81 |
| CT1/[(CT2 + CT3 + CT4)/3] | 1.89 | f/f2345 | 0.35 |
| ΣCT/ΣAT | 2.81 | f23/f | 1.30 |
| R5/Dr5I | −0.67 | TL/ImgH | 1.19 |
| R6/Dr6I | −0.57 | TL/f | 1.35 |

### 8th Embodiment

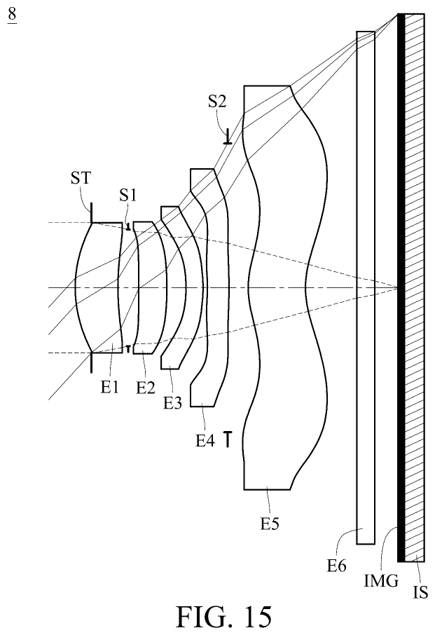

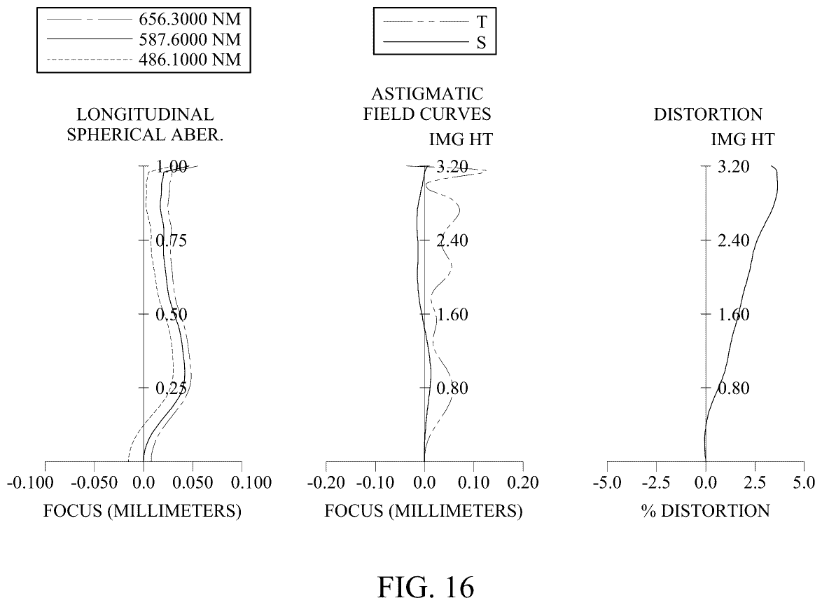

FIG. 15 is a schematic view of an image capturing unit according to the 8th embodiment of the present disclosure. FIG. 16 shows, in order from left to right, spherical aberration curves, astigmatic field curves and a distortion curve of the image capturing unit according to the 8th embodiment. In FIG. 15, the image capturing unit 8 includes the photographing lens system (its reference numeral is omitted) of the present disclosure and an image sensor IS. The photographing lens system includes, in order from an object side to an image side along an optical path, an aperture stop ST, a first lens element E1, a stop S1, a second lens element E2, a third lens element E3, a fourth lens element E4, a stop S2, a fifth lens element E5, a filter E6 and an image surface IMG. The photographing lens system includes five lens elements (E1, E2, E3, E4 and E5) with no additional lens element disposed between each of the adjacent five lens elements.

The first lens element E1 with positive refractive power has an object-side surface being convex in a paraxial region thereof and an image-side surface being concave in a paraxial region thereof. The first lens element E1 is made of glass material and has the object-side surface and the image-side surface being both aspheric. The object-side surface of the first lens element E1 has one inflection point. The image-side surface of the first lens element E1 has one inflection point. The image-side surface of the first lens element E1 has one critical point in an off-axis region thereof.

The second lens element E2 with positive refractive power has an object-side surface being convex in a paraxial region thereof and an image-side surface being convex in a paraxial region thereof. The second lens element E2 is made of glass material and has the object-side surface and the image-side surface being both aspheric. The object-side surface of the second lens element E2 has one inflection point. The object-side surface of the second lens element E2 has one critical point in an off-axis region thereof.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric. The image-side surface of the third lens element E3 has one inflection point.

The fourth lens element E4 with negative refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has three inflection points. The image-side surface of the fourth lens element E4 has five inflection points. The object-side surface of the fourth lens element E4 has two critical points in an off-axis region thereof. The image-side surface of the fourth lens element E4 has two critical points in an off-axis region thereof.

The fifth lens element E5 with positive refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has three inflection points. The image-side surface of the fifth lens element E5 has three inflection points. The object-side surface of the fifth lens element E5 has two critical points in an off-axis region thereof. The image-side surface of the fifth lens element E5 has one critical point in an off-axis region thereof.

The filter E6 is made of glass material and located between the fifth lens element E5 and the image surface IMG, and does not affect the focal length of the photographing lens system. The image sensor IS is disposed on or near the image surface IMG of the photographing lens system.

An average central thickness of the first lens element E1 to the fifth lens element E in the photographing lens system is 0.39 mm. Moreover, a central thickness of the first lens element E1 is 0.500 mm, and the central thickness (0.500 mm) of the first lens element E1 is larger than the average central thickness (0.39 mm) of all lens elements in the photographing lens system.

The detailed optical data of the 8th embodiment are shown in Table 8A and the aspheric surface data are shown in Table 8B below.

TABLE 8A
8th Embodiment
f = 2.81 mm, Fno = 1.85, HFOV = 47.6 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Ape. Stop | Plano | | −0.188 | | | | |
| 2 | Lens 1 | 1.4737 | (ASP) | 0.500 | Glass | 1.589 | 61.2 | 4.24 |
| 3 | | 3.1455 | (ASP) | 0.121 | | | | |
| 4 | Stop | Plano | | 0.121 | | | | |
| 5 | Lens 2 | 53.2393 | (ASP) | 0.330 | Glass | 1.589 | 61.2 | 6.37 |
| 6 | | −4.0282 | (ASP) | 0.224 | | | | |
| 7 | Lens 3 | −1.5851 | (ASP) | 0.200 | Plastic | 1.669 | 19.5 | 8.51 |
| 8 | | −1.3025 | (ASP) | 0.051 | | | | |
| 9 | Lens 4 | −1.5243 | (ASP) | 0.252 | Plastic | 1.639 | 23.5 | −3.40 |
| 10 | | −5.4347 | (ASP) | −0.015 | | | | |
| 11 | Stop | Plano | | 0.240 | | | | |
| 12 | Lens 5 | 0.9691 | (ASP) | 0.670 | Plastic | 1.534 | 56.0 | 6.45 |
| 13 | | 1.0235 | (ASP) | 0.600 | | | | |

| | | | | | | | |
|---|---|---|---|---|---|---|---|
| 14 | Filter | Plano | 0.210 | Glass | 1.517 | 64.2 | — |
| 15 | | Plano | 0.273 | | | | |
| 16 | Image | Plano | — | | | | |

Note:
Reference wavelength is 587.6 nm (d-line).
An effective radius of the stop S1 (Surface 4) is 0.682 mm.
An effective radius of the stop S2 (Surface 11) is 1.688 mm.

TABLE 8B
Aspheric Coefficients

| Surface # | 2 | 3 | 5 | 6 |
|---|---|---|---|---|
| k= | 1.25346E+00 | 1.20247E+01 | −9.90000E+01 | −5.05940E+01 |
| A4= | −1.145193684E−01 | −1.100386275E−01 | −2.107419071E−01 | −3.429255455E−01 |
| A6= | 2.031332702E−01 | 2.655862691E+00 | 3.916287149E−01 | 4.280696822E−01 |
| A8= | 2.030191226E+01 | −1.029685999E+02 | 2.372226847E+01 | −8.372118254E+00 |
| A10= | −5.439108836E+02 | 2.142941738E+03 | −7.784510811E+02 | 1.145722094E+02 |
| A12= | 7.018359011E+03 | −2.849728403E+04 | 1.113202308E+04 | −9.776593745E+02 |
| A14= | −5.640564303E+04 | 2.563999678E+05 | −9.720485144E+04 | 5.303543928E+03 |
| A16= | 3.063788982E+05 | −1.613855166E+06 | 5.697425479E+05 | −1.893652492E+04 |
| A18= | −1.165874539E+06 | 7.233917598E+06 | −2.332926561E+06 | 4.518865717E+04 |
| A20= | 3.150331553E+06 | −2.321130336E+07 | 6.773004841E+06 | −7.141746706E+04 |
| A22= | −6.024160210E+06 | 5.290533023E+07 | −1.389775499E+07 | 7.175482371E+04 |
| A24= | 7.976512909E+06 | −8.361020834E+07 | 1.971625679E+07 | −4.148731024E+04 |
| A26= | −6.960953516E+06 | 8.707865160E+07 | −1.839868649E+07 | 1.050312522E+04 |
| A28= | 3.603296957E+06 | −5.374074331E+07 | 1.015887429E+07 | — |
| A30= | −8.384126878E+05 | 1.488479677E+07 | −2.513846009E+06 | — |
| Surface # | 7 | 8 | 9 | 10 |
| k= | −5.21843E+00 | 0.00000E+00 | −1.00000E+00 | −8.57930E−02 |
| A4= | −3.061901034E−01 | 3.005145133E+00 | 4.135625470E+00 | 2.020877004E−01 |
| A6= | −7.776987236E+00 | −2.779968110E+01 | −2.773386793E+01 | 5.283226444E−03 |
| A8= | 9.128287618E+01 | 1.447245297E+02 | 1.248490542E+02 | −4.625932301E−01 |
| A10= | −6.474952913E+02 | −5.079926290E+02 | −3.892854858E+02 | 1.299549573E+00 |
| A12= | 2.813212497E+03 | 1.260981516E+03 | 8.422302151E+02 | −4.241603542E+00 |
| A14= | −4.750796624E+03 | −2.232996482E+03 | −1.247928749E+03 | 8.751262789E+00 |
| A16= | −2.121479971E+04 | 2.803931435E+03 | 1.194376271E+03 | −1.063355936E+01 |
| A18= | 1.720454169E+05 | −2.438640419E+03 | −5.887846194E+02 | 7.872856628E+00 |
| A20= | −5.841330286E+05 | 1.394156464E+03 | −9.450394762E+01 | −3.529398084E+00 |
| A22= | 1.202823802E+06 | −4.692285452E+02 | 3.583969010E+02 | 8.801009664E−01 |
| A24= | −1.593045997E+06 | 7.003390384E+01 | −2.423593109E+02 | −8.300959833E−02 |
| A26= | 1.331425117E+06 | — | 7.661287453E+01 | −8.796724168E−03 |
| A28= | −6.411809399E+05 | — | −9.778172653E+00 | 1.909394769E−03 |
| A30= | 1.358904094E+05 | — | — | — |

| Surface # | 12 | 13 |
|---|---|---|
| k= | −1.03871E+00 | −1.00000E+00 |
| A4= | −9.213337450E−01 | −5.203169361E−01 |
| A6= | 1.351593093E+00 | 5.598887842E−01 |
| A8= | −1.858747193E+00 | −6.436429550E−01 |
| A10= | 2.086151626E+00 | 6.531327913E−01 |
| A12= | −1.749279966E+00 | −5.163846207E−01 |
| A14= | 1.041577711E+00 | 3.005070474E−01 |
| A16= | −4.310495017E−01 | −1.262502899E−01 |
| A18= | 1.225339007E−01 | 3.790323647E−02 |
| A20= | −2.344879571E−02 | −8.015884592E−03 |
| A22= | 2.887695213E−03 | 1.162189438E−03 |
| A24= | −2.068683687E−04 | −1.096609550E−04 |
| A26= | 6.557173545E−06 | 6.052617210E−06 |
| A28= | — | −1.480003071E−07 |

In the 8th embodiment, the equation of the aspheric surface profiles of the aforementioned lens elements is the same as the equation of the 1st embodiment. Also, the definitions of these parameters shown in Table 80 below are the same as those stated in the 1st embodiment, with corresponding values for the 8th embodiment; therefore, an explanation in this regard will not be provided again.

Moreover, these parameters can be calculated from Table 8A and Table 8B3 as the following values and satisfy the following conditions:

TABLE 8C
Values of Optical and Physical Parameters/Definitions

| | | | |
|---|---|---|---|
| f [mm] | 2.81 | f/R5 | −1.78 |
| Fno | 1.85 | f/R6 | −2.16 |
| HFOV [deg.] | 47.6 | f/f5 | 0.44 |
| FOV [deg.] | 95.2 | f1/f2 | 0.67 |
| V3 + V4 | 43.0 | f5/f4 | −1.90 |
| V4 − V3 | 4.0 | \|f1/f3\| | 0.50 |
| V4/V5 | 0.42 | \|f2/f3\| | 0.75 |
| V5 − V4 | 32.5 | \|f4/f3\| | 0.40 |
| V1 + V2 | 122.6 | \|f5/f3\| | 0.76 |
| V2 − V3 | 41.8 | \|f4/f\| + \|f5/f\| | 3.50 |
| CT1/[(CT2 + CT3 + CT4)/3] | 1.92 | f/f2345 | 0.33 |
| ΣCT/ΣAT | 2.63 | f23/f | 1.36 |
| R5/Dr5I | −0.64 | TL/ImgH | 1.18 |
| R6/Dr6I | −0.57 | TL/f | 1.34 |

### 9th Embodiment

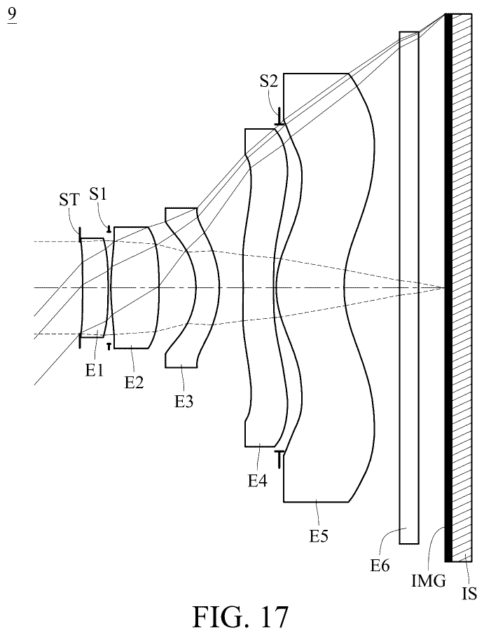

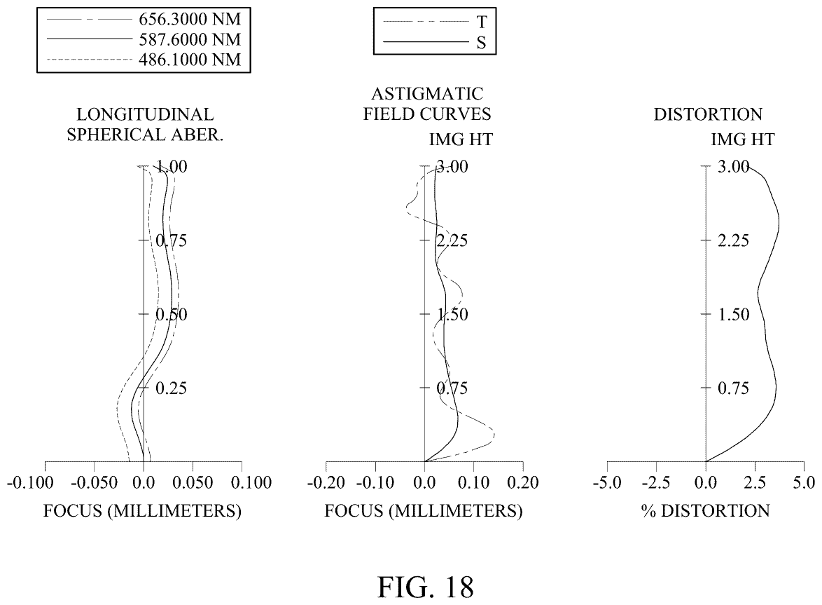

FIG. 17 is a schematic view of an image capturing unit according to the 9th embodiment of the present disclosure. FIG. 18 shows, in order from left to right, spherical aberration curves, astigmatic field curves and a distortion curve of the image capturing unit according to the 9th embodiment. In FIG. 17, the image capturing unit 9 includes the photographing lens system (its reference numeral is omitted) of the present disclosure and an image sensor IS. The photographing lens system includes, in order from an object side to an image side along an optical path, an aperture stop ST, a first lens element E1, a stop S1, a second lens element E2, a third lens element E3, a fourth lens element E4, a stop S2, a fifth lens element E5, a filter E6 and an image surface IMG. The photographing lens system includes five lens elements (E1, E2, E3, E4 and E5) with no additional lens element disposed between each of the adjacent five lens elements.

The first lens element E1 with positive refractive power has an object-side surface being concave in a paraxial region thereof and an image-side surface being convex in a paraxial region thereof. The first lens element E1 is made of plastic material and has the object-side surface and the image-side surface being both aspheric.

The second lens element E2 with positive refractive power has an object-side surface being convex in a paraxial region thereof and an image-side surface being convex in a paraxial region thereof. The second lens element E2 is made of plastic material and has the object-side surface and the image-side surface being both aspheric. The object-side surface of the second lens element E2 has one inflection point.

The third lens element E3 with negative refractive power has an object-side surface being concave in a paraxial region thereof and an image-side surface being convex in a paraxial region thereof. The third lens element E3 is made of plastic material and has the object-side surface and the image-side surface being both aspheric. The object-side surface of the third lens element E3 has one inflection point.

The image-side surface of the third lens element E3 has one inflection point. The image-side surface of the third lens element E3 has one critical point in an off-axis region thereof.

The fourth lens element E4 with negative refractive power has an object-side surface being concave in a paraxial region thereof and an image-side surface being concave in a paraxial region thereof. The fourth lens element E4 is made of plastic material and has the object-side surface and the image-side surface being both aspheric. The object-side surface of the fourth lens element E4 has three inflection points. The image-side surface of the fourth lens element E4 has two inflection points. The object-side surface of the fourth lens element E4 has two critical points in an off-axis region thereof. The image-side surface of the fourth lens element E4 has one critical point in an off-axis region thereof.

The fifth lens element E5 with positive refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has four inflection points. The image-side surface of the fifth lens element E5 has one inflection point. The object-side surface of the fifth lens element E5 has one critical point in an off-axis region thereof. The image-side surface of the fifth lens element E5 has one critical point in an off-axis region thereof.

The filter E6 is made of glass material and located between the fifth lens element E5 and the image surface IMG, and does not affect the focal length of the photographing lens system. The image sensor IS is disposed on or near the image surface IMG of the photographing lens system.

An average central thickness of the first lens element E1 to the fifth lens element E5 in the photographing lens system is 0.43 mm.

The detailed optical data of the 9th embodiment are shown in Table 9A and the aspheric surface data are shown in Table 9B below.

TABLE 9A
9th Embodiment
f = 2.61 mm, Fno = 2.58, HFOV = 48.2 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Ape. Stop | Plano | | 0.030 | | | | |
| 2 | Lens 1 | −100.0000 | (ASP) | 0.280 | Plastic | 1.545 | 56.1 | 36.60 |
| 3 | | −16.6439 | (ASP) | 0.009 | | | | |
| 4 | Stop | Plano | | 0.021 | | | | |
| 5 | Lens 2 | 2.1995 | (ASP) | 0.529 | Plastic | 1.544 | 56.0 | 2.76 |
| 6 | | −4.3283 | (ASP) | 0.404 | | | | |
| 7 | Lens 3 | −0.8490 | (ASP) | 0.257 | Plastic | 1.614 | 25.6 | −11.87 |
| 8 | | −1.0717 | (ASP) | 0.261 | | | | |
| 9 | Lens 4 | −5.2841 | (ASP) | 0.333 | Plastic | 1.614 | 25.6 | −6.69 |
| 10 | | 18.8679 | (ASP) | 0.063 | | | | |
| 11 | Stop | Plano | | −0.034 | | | | |
| 12 | Lens 5 | 1.0051 | (ASP) | 0.744 | Plastic | 1.544 | 56.0 | 4.10 |
| 13 | | 1.3533 | (ASP) | 0.607 | | | | |

| | | | | | | | |
|---|---|---|---|---|---|---|---|
| 14 | Filter | Plano | 0.210 | Glass | 1.517 | 64.2 | — |
| 15 | | Plano | 0.292 | | | | |
| 16 | Image | Plano | — | | | | |

Note:
Reference wavelength is 587.6 nm (d-line).
An effective radius of the stop S1 (Surface 4) is 0.614 mm.
An effective radius of the stop S2 (Surface 11) is 1.792 mm.

TABLE 9B
Aspheric Coefficients

| Surface # | 2 | 3 | 5 | 6 |
|---|---|---|---|---|
| k= | 4.95000E+01 | 2.98935E+00 | 0.00000E+00 | 0.00000E+00 |
| A4= | −1.430088097E−01 | −1.073755825E+00 | −6.135984935E−01 | −2.531824347E−01 |
| A6= | −6.113017479E+00 | 4.806397482E+00 | −6.202790127E+00 | 2.690148981E+00 |
| A8= | 1.632092877E+02 | −7.459919330E+00 | 2.848212406E+02 | −5.489149259E+01 |
| A10= | −2.601498708E+03 | −3.195577749E+02 | −5.311872707E+03 | 5.959655694E+02 |
| A12= | 2.540065640E+04 | 4.594167903E+03 | 6.133717094E+04 | −4.237495715E+03 |
| A14= | −1.432803264E+05 | −2.955802817E+04 | −4.760932840E+05 | 2.031924410E+04 |
| A16= | 3.015525184E+05 | 7.482179313E+04 | 2.564999723E+06 | −6.677191163E+04 |
| A18= | 1.650724913E+06 | 2.229741837E+05 | −9.707687857E+06 | 1.504341218E+05 |
| A20= | −1.512624505E+07 | −2.449574869E+06 | 2.571401043E+07 | −2.279967569E+05 |
| A22= | 5.241331955E+07 | 8.833990527E+06 | −4.664707198E+07 | 2.217230236E+05 |
| A24= | −9.045996100E+07 | −1.695587182E+07 | 5.516697263E+07 | −1.247377235E+05 |
| A26= | 6.424699127E+07 | 1.727233607E+07 | −3.827746035E+07 | 3.081639806E+04 |
| A28= | — | −7.346578572E+06 | 1.180469737E+07 | — |

| Surface # | 7 | 8 | 9 | 10 |
|---|---|---|---|---|
| k= | −2.89963E+00 | 0.00000E+00 | −1.34396E+00 | 0.00000E+00 |
| A4= | −5.099228845E−01 | 4.681486630E−01 | 4.547031641E−01 | 7.898429832E−01 |
| A6= | −5.211747682E+00 | −8.869255093E+00 | 2.303006510E+00 | −2.800582002E+00 |
| A8= | 1.069435196E+02 | 1.232765277E+02 | −1.799220998E+01 | 7.390850911E+00 |
| A10= | −1.077756145E+03 | −9.804485793E+02 | 6.040493741E+01 | −1.459714973E+01 |
| A12= | 6.495747881E+03 | 4.952993669E+03 | −1.301213945E+02 | 1.992969875E+01 |
| A14= | −2.546464608E+04 | −1.698137026E+04 | 1.961528863E+02 | −1.846191183E+01 |
| A16= | 6.765778139E+04 | 4.096436166E+04 | −2.126480100E+02 | 1.165476830E+01 |
| A18= | −1.228294765E+05 | −7.042042161E+04 | 1.669865161E+02 | −5.017906742E+00 |
| A20= | 1.498259881E+05 | 8.585725372E+04 | −9.462988805E+01 | 1.451104759E+00 |
| A22= | −1.172248216E+05 | −7.254198328E+04 | 3.814056962E+01 | −2.698335051E−01 |
| A24= | 5.307713211E+04 | 4.037724684E+04 | −1.061165684E+01 | 2.916494592E−02 |
| A26= | −1.056353790E+04 | −1.330707075E+04 | 1.926252154E+00 | −1.392860160E−03 |
| A28= | — | 1.965025568E+03 | −2.037461269E−01 | — |
| A30= | — | — | 9.420445409E−03 | — |

| Surface # | 12 | 13 |
|---|---|---|
| k= | −1.00000E+00 | −7.00185E−01 |
| A4= | 1.720738692E−01 | 1.452687272E−01 |
| A6= | −2.410500228E+00 | −1.091858595E+00 |
| A8= | 6.321754995E+00 | 1.987529252E+00 |
| A10= | −9.511131008E+00 | −2.158461011E+00 |
| A12= | 8.879496737E+00 | 1.531328849E+00 |
| A14= | −5.211909356E+00 | −7.363179082E−01 |
| A16= | 1.866728200E+00 | 2.441419643E−01 |
| A18= | −3.518617095E−01 | −5.588812291E−02 |
| A20= | 5.001322409E−03 | 8.677445294E−03 |
| A22= | 1.303963682E−02 | −8.726001310E−04 |
| A24= | −2.827175426E−03 | 5.127544099E−05 |
| A26= | 2.516229891E−04 | −1.336883888E−06 |
| A28= | −8.263205303E−06 | — |
| A30= | 1.886145517E−08 | — |

In the 9th embodiment, the equation of the aspheric surface profiles of the aforementioned lens elements is the same as the equation of the 1st embodiment. Also, the definitions of these parameters shown in Table 90 below are the same as those stated in the 1st embodiment, with corresponding values for the 9th embodiment; therefore, an explanation in this regard will not be provided again.

Moreover, these parameters can be calculated from Table 9A and Table 9B3 as the following values and satisfy the following conditions:

TABLE 9C
Values of Optical and Physical Parameters/Definitions

| | | | |
|---|---|---|---|
| f [mm] | 2.61 | f/R5 | −3.08 |
| Fno | 2.58 | f/R6 | −2.44 |
| HFOV [deg.] | 48.2 | f/f5 | 0.64 |
| FOV [deg.] | 96.4 | f1/f2 | 13.26 |
| V3 + V4 | 51.2 | f5/f4 | −0.61 |
| V4 − V3 | 0.0 | \|f1/f3\| | 3.08 |
| V4/V5 | 0.46 | \|f2/f3\| | 0.23 |
| V5 − V4 | 30.4 | \|f4/f3\| | 0.56 |
| V1 + V2 | 112.1 | \|f5/f3\| | 0.35 |
| V2 − V3 | 30.4 | \|f4/f\| + \|f5/f\| | 4.13 |
| CT1/[(CT2 + CT3 + CT4)/3] | 0.75 | f/f2345 | 0.93 |
| ΣCT/ΣAT | 2.96 | f23/f | 1.45 |
| R5/Dr5I | −0.31 | TL/ImgH | 1.32 |
| R6/Dr6I | −0.43 | TL/f | 1.52 |

### 10th Embodiment

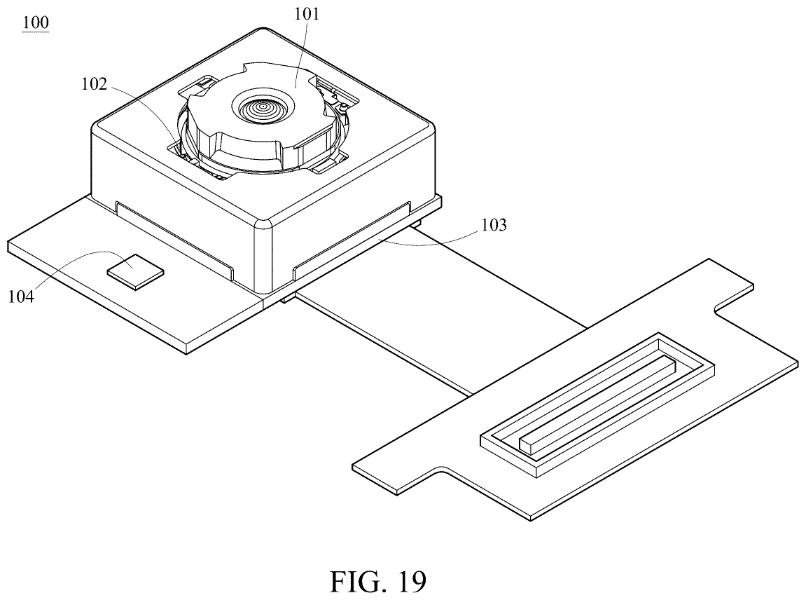

FIG. 19 is a perspective view of an image capturing unit according to the 10th embodiment of the present disclosure. In this embodiment, an image capturing unit 100 is a camera module including a lens unit 101, a driving device 102, an image sensor 103 and an image stabilizer 104. The lens unit 101 includes the photographing lens system as disclosed in the 1st embodiment, a barrel and a holder member (their reference numerals are omitted) for holding the photographing lens system. However, the lens unit 101 may alternatively be provided with the photographing lens system as disclosed in other embodiments of the present disclosure, and the present disclosure is not limited thereto. The imaging light converges in the lens unit 101 of the image capturing unit 100 to generate an image with the driving device 102 utilized for image focusing on the image sensor 103, and the generated image is then digitally transmitted to other electronic component for further processing.

The driving device 102 can have an auto-focusing function, and the driving device 102 can utilize various driving configurations, such as voice coil motors (VCM), micro electro-mechanical systems (MEMS), piezoelectric systems, and shape memory alloys. The driving device 102 is favorable for obtaining a better imaging position for the lens unit 101, so that a clear image of the imaged object can be captured by the lens unit 101 with different object distances. The image sensor 103 (for example, CMOS or CCD), which can feature high photosensitivity and low noise, is disposed on the image surface of the photographing lens system to provide higher image quality.

The image stabilizer 104, such as an accelerometer, a gyro sensor and a Hall Effect sensor, is configured to work with the driving device 102 to provide optical image stabilization (OIS). The driving device 102 working with the image stabilizer 104 is favorable for compensating for pan and tilt of the lens unit 101 to reduce blurring associated with motion during exposure. In some cases, the compensation can be provided by electronic image stabilization (EIS) with image processing software, thereby improving image quality while in dynamic or low-light scenarios.

### 11th Embodiment

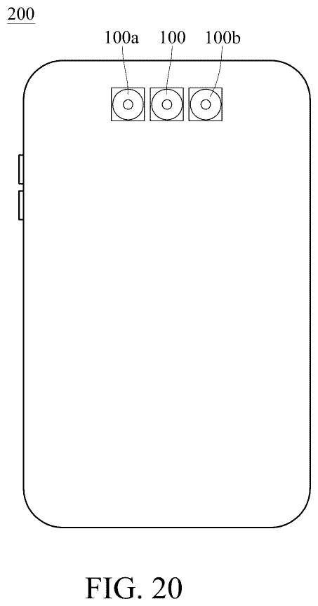

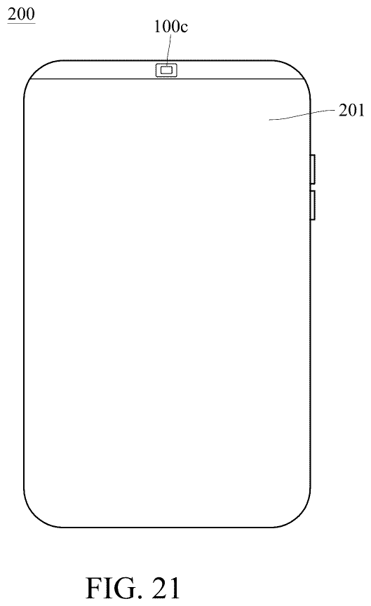

FIG. 20 is one schematic view of an electronic device according to the 11th embodiment of the present disclosure, and FIG. 21 is another schematic view of the electronic device in FIG. 20.

In this embodiment, an electronic device 200 is a smartphone including the image capturing unit 100 as disclosed in the 10th embodiment, an image capturing unit 100a, an image capturing unit 100b, an image capturing unit 100c and a display module 201. As shown in FIG. 20, the image capturing unit 100, the image capturing unit 100a and the image capturing unit 100b are disposed on the same side of the electronic device 200, and each of the image capturing units 100, 100a and 100b has a single focal point. As shown in FIG. 21, the image capturing unit 100c and the display module 201 are disposed on the opposite side of the electronic device 200, allowing the image capturing unit 100c to serve as a front-facing camera of the electronic device 200 for taking selfies, but the present disclosure is not limited thereto. Furthermore, each of the image capturing units 100a, 100b and 100c can include the photographing lens system of the present disclosure and can have a configuration similar to that of the image capturing unit 100. In detail, each of the image capturing units 100a, 100b and 100c can include a lens unit, a driving device, an image sensor and an image stabilizer. In addition, each lens unit of the image capturing units 100a, 100b and 100c can include the photographing lens system of the present disclosure, a barrel and a holder member for holding the photographing lens system.

The image capturing unit 100 is a wide-angle image capturing unit, the image capturing unit 100a is a telephoto image capturing unit, the image capturing unit 100b is an ultra-wide-angle image capturing unit, and the image capturing unit 100c is a wide-angle image capturing unit. In this embodiment, the image capturing units 100, 100a and 100b have different fields of view, such that the electronic device 200 can have various magnification ratios so as to meet the requirement of optical zoom functionality. Moreover, as shown in FIG. 21, the image capturing unit 100c can have a non-circular opening, and the barrel or lens elements in the image capturing unit 100c can have trimmed edges at their outermost positions so as to coordinate with the shape of the non-circular opening. Therefore, it is favorable for reducing the size of the image capturing unit 100c so as to increase the ratio of the area of the display module 201 relative to that of the electronic device 200, and reduce the thickness of the electronic device 200, thereby achieving module miniaturization. In this embodiment, the electronic device 200 includes multiple image capturing units 100, 100a, 100b and 100c, but the present disclosure is not limited to the number and arrangement of image capturing units.

### 12th Embodiment

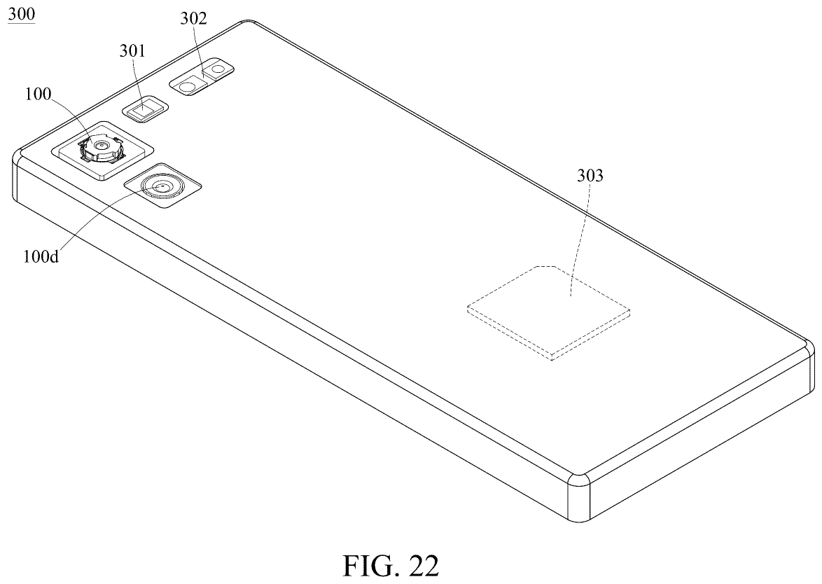

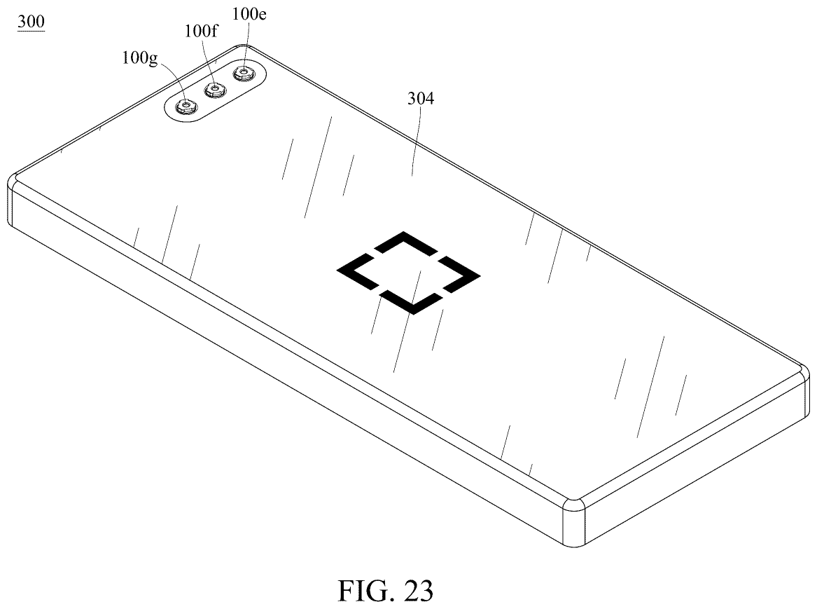

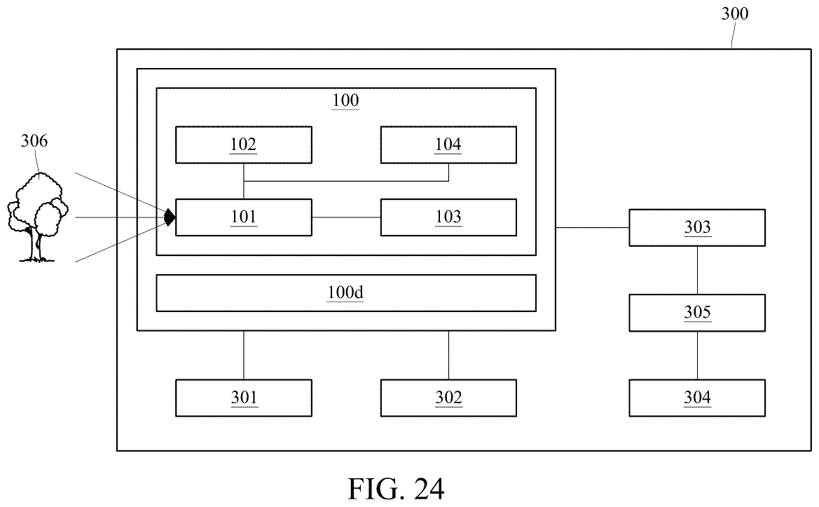

FIG. 22 is one perspective view of an electronic device according to the 12th embodiment of the present disclosure, FIG. 23 is another perspective view of the electronic device in FIG. 22, and FIG. 24 is a block diagram of the electronic device in FIG. 22.

In this embodiment, an electronic device 300 is a smartphone including the image capturing unit 100 as disclosed in the 10th embodiment, an image capturing unit 100d, an image capturing unit 100e, an image capturing unit 100f, an image capturing unit 100g, a flash module 301, a focus assist module 302, an image signal processor 303, a display module 304 and an image software processor 305. The image capturing unit 100 and the image capturing unit 100d are disposed on the same side of the electronic device 300. The focus assist module 302 can be a laser rangefinder or a ToF (time of flight) module, but the present disclosure is not limited thereto. The image capturing unit 100e, image capturing unit 100f, the image capturing unit 100g and the display module 304 are disposed on the opposite side of the electronic device 300, and the display module 304 can serve as a user interface, allowing the image capturing units 100e, 100f and 100g to serve as front-facing cameras of the electronic device 300 for taking selfies, but the present disclosure is not limited thereto. Furthermore, each of the image capturing units 100d, 100e, 100f and 100g can include the photographing lens system of the present disclosure and can have a configuration similar to that of the image capturing unit 100. In detail, each of the image capturing units 100d, 100e, 100f and 100g can include a lens unit, a driving device, an image sensor and an image stabilizer. In addition, each lens unit of the image capturing units 100d, 100e, 100f and 100g can include the photographing lens system of the present disclosure, a barrel and a holder member for holding the photographing lens system.

The image capturing unit 100 is a wide-angle image capturing unit, the image capturing unit 100d is an ultra-wide-angle image capturing unit, the image capturing unit 100e is a wide-angle image capturing unit, the image capturing unit 100f is an ultra-wide-angle image capturing unit, and the image capturing unit 100g is a ToF image capturing unit. In this embodiment, the image capturing units 100 and 100d have different fields of view, such that the electronic device 300 can have various magnification ratios so as to meet the requirement of optical zoom functionality. In addition, the image capturing unit 100g can obtain depth information of the imaged object. In this embodiment, the electronic device 300 includes multiple image capturing units 100, 100d, 100e, 100f and 100g, but the present disclosure is not limited to the number and arrangement of image capturing units.

When a user captures images of an object 306, the light rays converge in the image capturing unit 100 or the image capturing unit 100d to generate images, and the flash module 301 is activated for light supplement. The focus assist module 302 detects the object distance of the imaged object 306 to achieve fast auto focusing.

The image signal processor 303 is configured to optimize the captured image to improve image quality. The light beam emitted from the focus assist module 302 can be either conventional infrared or laser. In addition, the light rays may converge in the image capturing unit 100e, 100f or 100g to generate images. The display module 304 can include a touch screen, and the user is able to interact with the display module 304 and the image software processor 305 having multiple functions to capture images and complete image processing. Alternatively, the user may capture images via a physical button. The image processed by the image software processor 305 can be displayed on the display module 304.

### 13th Embodiment

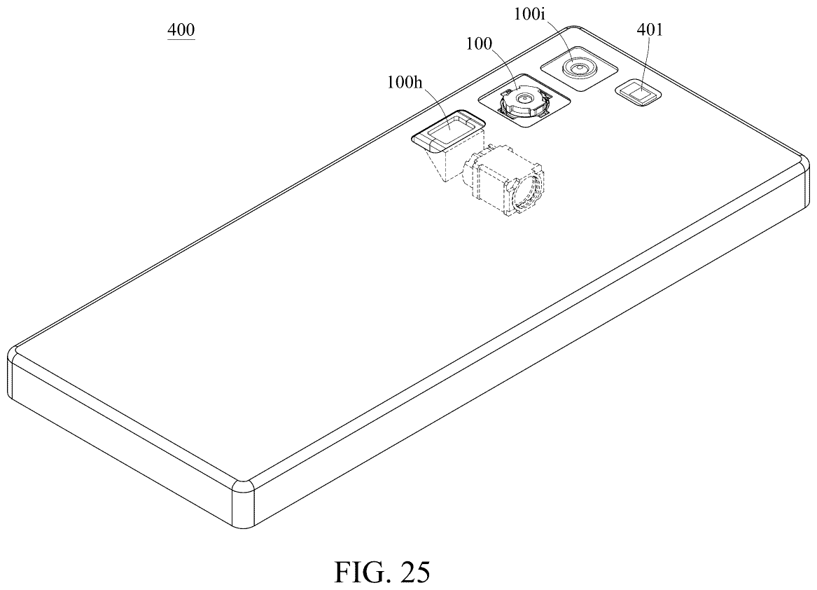

FIG. 25 is a perspective view of an electronic device according to the 13th embodiment of the present disclosure.

In this embodiment, an electronic device 400 is a smartphone including the image capturing unit 100 as disclosed in the 10th embodiment, an image capturing unit 100h, an image capturing unit 100i, a flash module 401, a focus assist module, an image signal processor, a display module, and an image software processor (not shown). The image capturing units 100, 100h and 100i are disposed on the same side of the electronic device 400, while the display module is disposed on the opposite side of the electronic device 400. Furthermore, each of the image capturing units 100h and 100i can include the photographing lens system of the present disclosure and can have a configuration similar to that of the image capturing unit 100, and the details in this regard will not be provided again.

The image capturing unit 100 is a wide-angle image capturing unit, the image capturing unit 100h is a telephoto image capturing unit, and the image capturing unit 100i is an ultra-wide-angle image capturing unit. In this embodiment, the image capturing units 100, 100h and 100i have different fields of view, such that the electronic device 400 can have various magnification ratios so as to meet the requirement of optical zoom functionality. In addition, the image capturing unit 100h is a telephoto image capturing unit configured with an optical path folding element, allowing the total track length of the image capturing unit 100h to be unrestricted by the thickness of the electronic device 400. Moreover, the light-folding configuration of the image capturing unit 100h can be similar to, for example, one of the configurations as shown in FIG. 28 to FIG. 30, which can be referred to foregoing descriptions corresponding to FIG. 28 to FIG. 30, and the details in this regard will not be provided again. In this embodiment, the electronic device 400 includes multiple image capturing units 100, 100h and 100i, but the present disclosure is not limited to the number and arrangement of image capturing units. When a user captures images of an object, the light rays converge in the image capturing unit 100, 100h or 100i to generate images, and the flash module 401 is activated for light supplement. Further, the subsequent processes are performed in a manner similar to the abovementioned embodiments, and the details in this regard will not be provided again.

### 14th Embodiment

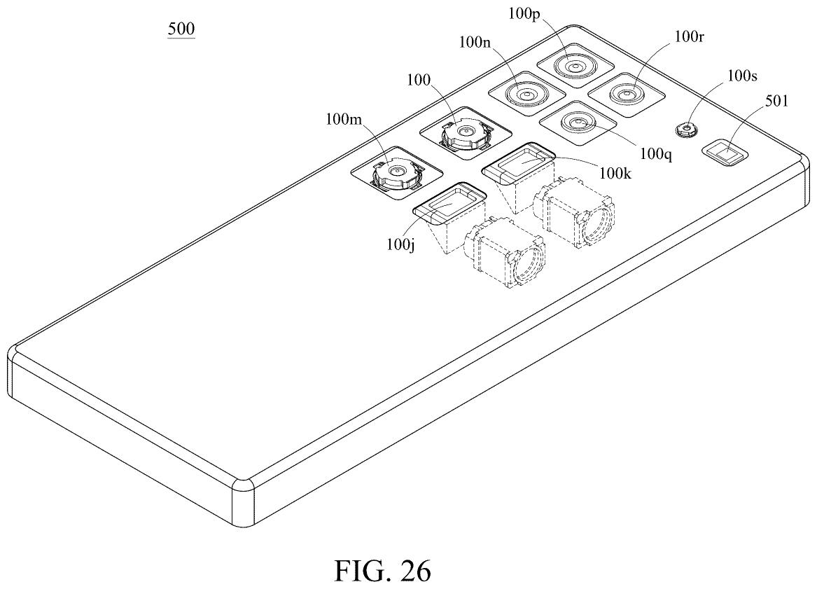

FIG. 26 is a perspective view of an electronic device according to the 14th embodiment of the present disclosure.

In this embodiment, an electronic device 500 is a smartphone including the image capturing unit 100 as disclosed in the 10th embodiment, an image capturing unit 100j, an image capturing unit 100k, an image capturing unit 100m, an image capturing unit 100n, an image capturing unit 100p, an image capturing unit 100q, an image capturing unit 100r, an image capturing unit 100s, a flash module 501, a focus assist module, an image signal processor, a display module, and an image software processor (not shown). The image capturing units 100, 100j, 100k, 100m, 100n, 100p, 100q, 100r and 100s are disposed on the same side of the electronic device 500, while the display module is disposed on the opposite side of the electronic device 500. Furthermore, each of the image capturing units 100j, 100k, 100m, 100n, 100p, 100q, 100r and 100s can include the photographing lens system of the present disclosure and can have a configuration similar to that of the image capturing unit 100, and the details in this regard will not be provided again.

The image capturing unit 100 is a wide-angle image capturing unit, the image capturing unit 100j is a telephoto image capturing unit, the image capturing unit 100k is a telephoto image capturing unit, the image capturing unit 100m is a wide-angle image capturing unit, the image capturing unit 100n is an ultra-wide-angle image capturing unit, the image capturing unit 100p is an ultra-wide-angle image capturing unit, the image capturing unit 100q is a telephoto image capturing unit, the image capturing unit 100r is a telephoto image capturing unit, and the image capturing unit 100s is a ToF image capturing unit. In this embodiment, the image capturing units 100, 100j, 100k, 100m, 100n, 100p, 100q and 100r have different fields of view, such that the electronic device 500 can have various magnification ratios so as to meet the requirement of optical zoom functionality. In addition, each of the image capturing unit 100j and the image capturing unit 100k is a telephoto image capturing unit configured with an optical path folding element. Moreover, the light-folding configuration of the image capturing units 100j and 100k can be similar to, for example, one of the configurations as shown in FIG. 28 to FIG. 30, which can be referred to foregoing descriptions corresponding to FIG. 28 to FIG. 30, and the details in this regard will not be provided again. Moreover, the image capturing unit 100s can obtain depth information of the imaged object. In this embodiment, the electronic device 500 includes multiple image capturing units 100, 100j, 100k, 100m, 100n, 100p, 100q, 100r and 100s, but the present disclosure is not limited to the number and arrangement of image capturing units. When a user captures images of an object, the light rays converge in the image capturing unit 100, 100j, 100k, 100m, 100n, 100p, 100q, 100r or 100s to generate images, and the flash module 501 is activated for light supplement. Further, the subsequent processes are performed in a manner similar to the abovementioned embodiments, and the details in this regard will not be provided again.

The smartphones in the embodiments are only exemplary for showing the image capturing unit of the present disclosure installed in an electronic device, and the present disclosure is not limited thereto. The image capturing unit can be optionally applied to optical systems with a movable focus. Furthermore, the photographing lens system of the image capturing unit features good capability in aberration corrections and high image quality, and can be applied to 3D (three-dimensional) image capturing applications, in products such as digital cameras, mobile devices, digital tablets, notebook computers, smart televisions, network surveillance devices, dashboard cameras, vehicle backup cameras, multi-camera devices, image recognition systems, motion sensing input devices, wearable devices, and other electronic imaging devices.

The foregoing description, for the purpose of explanation, has been described with reference to specific embodiments. It is to be noted that TABLES 1A-9C show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A photographing lens system comprising five lens elements, the five lens elements being, in order from an object side to an image side along an optical path, a first lens element, a second lens element, a third lens element, a fourth lens element and a fifth lens element, and each of the five lens elements having an object-side surface facing toward the object side and an image-side surface facing toward the image side;
wherein the first lens element has positive refractive power, the second lens element has positive refractive power, the object-side surface of the third lens element is concave in a paraxial region thereof, the image-side surface of the third lens element is convex in a paraxial region thereof, the fourth lens element has negative refractive power, the object-side surface of the fourth lens element is concave in a paraxial region thereof, the fifth lens element has positive refractive power, the object-side surface of the fifth lens element is convex in a paraxial region thereof, and the image-side surface of the fifth lens element is concave in a paraxial region thereof;
wherein an Abbe number of the third lens element is V3, an Abbe number of the fourth lens element is V4, a focal length of the third lens element is f3, a focal length of the fourth lens element is f4, a focal length of the fifth lens element is f5, a focal length of the photographing lens system is f, and the following conditions are satisfied:
$$20. < V 3 + V 4 < 65. ; \\ 0. < \vert f 4 / f 3 \vert < 0.8 ; and \\ 1.5 < \vert f 4 / f \vert + \vert f 5 / f \vert < 7. .$$

2. The photographing lens system of claim 1, wherein the image-side surface of the fourth lens element is convex in a paraxial region thereof.

3. The photographing lens system of claim 1, wherein the Abbe number of the third lens element is V3, the Abbe number of the fourth lens element is V4, and the following condition is satisfied:
$$0. \leq V 4 - V 3 < 10.00 .$$

4. The photographing lens system of claim 1, further comprising an aperture stop disposed on an object side of the first lens element.

5. The photographing lens system of claim 1, wherein the image-side surface of the fifth lens element has at least one critical point in an off-axis region thereof.

6. The photographing lens system of claim 1, wherein the focal length of the photographing lens system is f, a curvature radius of the image-side surface of the third lens element is R6, and the following condition is satisfied:
$$- 4.00 < f / R 6 < - 1. .$$

7. The photographing lens system of claim 1, wherein a curvature radius of the object-side surface of the third lens element is R5, a curvature radius of the image-side surface of the third lens element is R6, an axial distance between the object-side surface of the third lens element and an image surface is Dr5I, an axial distance between the image-side surface of the third lens element and the image surface is Dr6I, and the following conditions are satisfied:
$$- 1.25 < R 5 / Dr 5 I < - 0 \text{.20} ; and \\ - 1.5 < R 6 / Dr 6 I < - 0.25 .$$

8. The photographing lens system of claim 1, wherein the image-side surface of the fifth lens element has at least one inflection point; and
wherein an axial distance between the object-side surface of the first lens element and an image surface is TL, a maximum image height of the photographing lens system is ImgH, the focal length of the photographing lens system is f, and the following conditions are satisfied:
$$1. 00 < TL / ImgH < 1.5 ; and \\ 1. < TL / f < 1.8 .$$

9. The photographing lens system of claim 1, wherein the Abbe number of the fourth lens element is V4, an Abbe number of the fifth lens element is V5, and the following condition is satisfied:
$$0.2 < V 4 / V 5 < 0.60 .$$

10. The photographing lens system of claim 1, wherein half of a maximum field of view of the photographing lens system is HFOV, and the following condition is satisfied:
$$40. degrees < HFOV < 60. degrees$$

11. The photographing lens system of claim 1, wherein the focal length of the photographing lens system is f, a composite focal length of the second lens element, the third lens element, the fourth lens element and the fifth lens element is f2345, and the following condition is satisfied:
$$0. < f / f 2345 < 1. .$$

12. An image capturing unit comprising:
the photographing lens system of claim 1; and
an image sensor disposed on an image surface of the photographing lens system.

13. A photographing lens system comprising five lens elements, the five lens elements being, in order from an object side to an image side along an optical path, a first lens element, a second lens element, a third lens element, a fourth lens element and a fifth lens element, and each of the five lens elements having an object-side surface facing toward the object side and an image-side surface facing toward the image side;
wherein the first lens element has positive refractive power, the second lens element has positive refractive power, the object-side surface of the third lens element is concave in a paraxial region thereof, the image-side surface of the third lens element is convex in a paraxial region thereof, the fourth lens element has negative refractive power, the object-side surface of the fourth lens element is concave in a paraxial region thereof, the fifth lens element has positive refractive power, the object-side surface of the fifth lens element is convex in a paraxial region thereof, and the image-side surface of the fifth lens element is concave in a paraxial region thereof;
wherein an Abbe number of the third lens element is V3, an Abbe number of the fourth lens element is V4, an Abbe number of the fifth lens element is V5, a composite focal length of the second lens element and the third lens element is f23, a focal length of the photographing lens system is f, and the following conditions are satisfied:
$$20. < V 3 + V 4 < 65. ; \\ 1.15 < f 23 / f < 5. ; and \\ 25. < V 5 - V 4 < 45.0 .$$

14. The photographing lens system of claim 13, wherein the object-side surface of the first lens element is convex in a paraxial region thereof, and the image-side surface of the second lens element is convex in a paraxial region thereof.

15. The photographing lens system of claim 13, wherein an Abbe number of the first lens element is V1, an Abbe number of the second lens element is V2, the Abbe number of the third lens element is V3, and the following conditions are satisfied:
$$100. < V 1 + V 2 < 130. ; and \\ 25. < V 2 - V 3 < 45.0 .$$

16. The photographing lens system of claim 13, wherein the focal length of the photographing lens system is f, a focal length of the fifth lens element is f5, and the following condition is satisfied:
$$0.25 < f / f 5 < 1. .$$

17. The photographing lens system of claim 13, wherein an Abbe number of the second lens element is V2, the Abbe number of the third lens element is V3, the Abbe number of the fourth lens element is V4, and the following conditions are satisfied:
$$V 3 < V 2 ; and \\ V 3 \leq V 4.$$

18. The photographing lens system of claim 13, wherein a central thickness of the first lens element is larger than an average central thickness of all lens elements in the photographing lens system; and
wherein an axial distance between the object-side surface of the first lens element and an image surface is TL, a maximum image height of the photographing lens system is ImgH, and the following condition is satisfied:
$$1. 15 < TL / ImgH < 1.35 .$$

19. The photographing lens system of claim 13, wherein at least one of the first lens element and the second lens element is made of glass material.

20. The photographing lens system of claim 13, wherein the Abbe number of the third lens element is V3, the Abbe number of the fourth lens element is V4, the Abbe number of the fifth lens element is V5, a focal length of the third lens element is f3, a focal length of the fourth lens element is f4, a focal length of the fifth lens element is f5, the focal length of the photographing lens system is f, the composite focal length of the second lens element and the third lens element is f23, a curvature radius of the object-side surface of the third lens element is R5, and the following conditions are satisfied:
$$25. < V 3 + V 4 < 55. ; \\ 0. < \vert f 4 / f 3 \vert < 0.6 ; \\ 1.8 < \vert f 4 / f \vert + \vert f 5 / f \vert < 5.5 ; \\ 1.25 < f 23 / f < 4. ; \\ 26. < V 5 - V 4 < 43. ; \\ - 2.2 < f / R 5 < - 1.2 ; and \\ - 2.1 < f 5 / f 4 < - 1.1 .$$

21. A photographing lens system comprising five lens elements, the five lens elements being, in order from an object side to an image side along an optical path, a first lens element, a second lens element, a third lens element, a fourth lens element and a fifth lens element, and each of the five lens elements having an object-side surface facing toward the object side and an image-side surface facing toward the image side;
wherein the first lens element has positive refractive power, the second lens element has positive refractive power, the object-side surface of the third lens element is concave in a paraxial region thereof, the image-side surface of the third lens element is convex in a paraxial region thereof, the fourth lens element has negative refractive power, the object-side surface of the fourth lens element is concave in a paraxial region thereof, the fifth lens element has positive refractive power, the object-side surface of the fifth lens element is convex in a paraxial region thereof, and the image-side surface of the fifth lens element is concave in a paraxial region thereof;
wherein an Abbe number of the third lens element is V3, an Abbe number of the fourth lens element is V4, a focal length of the photographing lens system is f, a focal length of the fourth lens element is f4, a focal length of the fifth lens element is f5, a curvature radius of the object-side surface of the third lens element is R5, and the following conditions are satisfied:
$$20. < V 3 + V 4 < 65. ; \\ - 3. < f / R 5 < - 1. ; and \\ - 2.2 < f 5 / f 4 < - 1. .$$

22. The photographing lens system of claim 21, wherein the image-side surface of the first lens element is concave in a paraxial region thereof, and the image-side surface of the second lens element is convex in a paraxial region thereof.

23. The photographing lens system of claim 21, wherein a central thickness of the first lens element is CT1, a central thickness of the second lens element is CT2, a central thickness of the third lens element is CT3, a central thickness of the fourth lens element is CT4, a sum of central thicknesses of all lens elements of the photographing lens system is ΣCT, a sum of axial distances between each of all adjacent lens elements of the photographing lens system is ZAT, and the following conditions are satisfied:
$$1.1 < CT 1 / [ ( CT 2 + CT 3 + CT 4 ) / 3 ] < 2.5 ; and \\ 2. < \sum CT / \sum AT < 5.00 .$$

24. The photographing lens system of claim 21, wherein a focal length of the first lens element is f1, a focal length of the second lens element is f2, a focal length of the third lens element is f3, the focal length of the fourth lens element is f4, the focal length of the fifth lens element is f5, and the following conditions are satisfied:
$$0. < \vert f 1 / f 3 \vert < 1. ; \\ 0. < \vert f 2 / f 3 \vert < 1.5 ; \\ 0. < \vert f 4 / f 3 \vert < 1. ; and \\ 0. < \vert f 5 / f 3 \vert < 1. .$$

25. The photographing lens system of claim 21, wherein a focal length of the first lens element is f1, a focal length of the second lens element is f2, and the following condition is satisfied:
$$0.2 < f 1 / f 2 < 1. .$$

26. An electronic device comprising:
an image capturing unit comprising:
the photographing lens system of claim 21; and
an image sensor disposed on an image surface of the photographing lens system.

27. The photographing lens system of claim 21, wherein the Abbe number of the third lens element is V3, the Abbe number of the fourth lens element is V4, an Abbe number of the fifth lens element is V5, a focal length of the third lens element is f3, the focal length of the fourth lens element is f4, the focal length of the fifth lens element is f5, the focal length of the photographing lens system is f, a composite focal length of the second lens element and the third lens element is f23, the curvature radius of the object-side surface of the third lens element is R5, and the following conditions are satisfied:
$$28. \leq V 3 + V 4 \leq 51.2 ; \\ 0.01 \leq \vert f 4 / f 3 \vert \leq 0.56 ; \\ 2.08 \leq \vert f 4 / f \vert + \vert f 5 / f \vert \leq 5.24 ; \\ 1.3 \leq f 23 / f \leq 3.87 ; \\ 27.7 \leq V 5 - V 4 \leq 42. ; \\ - 2.08 \leq f / R 5 \leq - 1.31 ; and \\ - 1.9 \leq f 5 / f 4 \leq - 1.14 .$$
